(19) United States
(12) Patent Application Publication
(10) Pub. No.: US 2026/0239335 A1
(43) Pub. Date: Aug. 13, 2026

(54) ACTIVATION INDICATION FOR MULTIPLE PHYSICAL UPLINK SHARED CHANNEL CONFIGURED GRANT

(71) Applicant: QUALCOMM Incorporated, San Diego, CA (US)

(72) Inventors: Fang YUAN, Beijing (CN); Iyab Issam SAKHNINI, San Diego, CA (US)

(21) Appl. No.: 19/153,379

(22) PCT Filed: Apr. 7, 2023
(86) PCT No.: PCT/CN2023/086903

§ 371 Date: Aug. 4, 2025

(51) Int. Cl. H04W 72/1268; H04W 72/0446

(52) U.S. Cl. CPC H04W 72/1268; H04W 72/0446

(57) ABSTRACT

Various aspects of the present disclosure generally relate to wireless communication. In some aspects, a user equipment (UE) may receive, from a network node, configuration information indicating a configuration for a multiple physical uplink shared channel (PUSCH) configured grant (multi-PUSH CG). The UE may receive, from the network node, an activation indication for the multi-PUSCH CG, the activation indication indicating one or more per-PUSCH uplink transmission parameters for multiple PUSCH communications associated with the multi-PUSCH CG. The UE may transmit, to the network node, the multiple PUSCH communications associated with the multi-PUSCH CG in accordance with the one or more per-PUSCH uplink transmission parameters. Numerous other aspects are described.

### FIELD OF THE DISCLOSURE

Aspects of the present disclosure generally relate to wireless communication and to techniques and apparatuses for activation indication for multiple physical uplink shared channel (multi-PUSCH) configured grant (CG).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a network node, configuration information indicating a configuration for a multiple physical uplink shared channel (PUSCH) configured grant (multi-PUSH CG). The one or more processors may be configured to receive, from the network node, an activation indication for the multi-PUSCH CG, the activation indication indicating one or more per-PUSCH uplink transmission parameters for multiple PUSCH communications associated with the multi-PUSCH CG. The one or more processors may be configured to transmit, to the network node, the multiple PUSCH communications associated with the multi-PUSCH CG in accordance with the one or more per-PUSCH uplink transmission parameters.

Some aspects described herein relate to a network node for wireless communication. The network node may include a memory and one or more processors coupled to the memory. The one or more processors may be configured to transmit, to a UE configuration information indicating a configuration for a multi-PUSH CG. The one or more processors may be configured to transmit, to the UE, an activation indication for the multi-PUSCH CG, the activation indication indicating one or more per-PUSCH uplink transmission parameters for multiple PUSCH communications associated with the multi-PUSCH CG. The one or more processors may be configured to receive, from the UE, the multiple PUSCH communications associated with the multi-PUSCH CG in accordance with the one or more per-PUSCH uplink transmission parameters.

Some aspects described herein relate to a method of wireless communication performed by a UE. The method may include receiving, from a network node, configuration information indicating a configuration for a multi-PUSH CG. The method may include receiving, from the network node, an activation indication for the multi-PUSCH CG, the activation indication indicating one or more per-PUSCH uplink transmission parameters for multiple PUSCH communications associated with the multi-PUSCH CG. The method may include transmitting, to the network node, the multiple PUSCH communications associated with the multi-PUSCH CG in accordance with the one or more per-PUSCH uplink transmission parameters.

Some aspects described herein relate to a method of wireless communication performed by a network node. The method may include transmitting, to a UE configuration information indicating a configuration for a multi-PUSH CG. The method may include transmitting, to the UE, an activation indication for the multi-PUSCH CG, the activation indication indicating one or more per-PUSCH uplink transmission parameters for multiple PUSCH communications associated with the multi-PUSCH CG. The method may include receiving, from the UE, the multiple PUSCH communications associated with the multi-PUSCH CG in accordance with the one or more per-PUSCH uplink transmission parameters.

Some aspects described herein relate to a non-transitory computer-readable medium that stores a set of instructions for wireless communication by a UE. The set of instructions, when executed by one or more processors of the UE, may cause the UE to receive, from a network node, configuration information indicating a configuration for a multi-PUSH CG. The set of instructions, when executed by one or more processors of the UE, may cause the UE to receive, from the network node, an activation indication for the multi-PUSCH CG, the activation indication indicating one or more per-PUSCH uplink transmission parameters for multiple PUSCH communications associated with the multi-PUSCH CG. The set of instructions, when executed by one or more processors of the UE, may cause the UE to transmit, to the network node, the multiple PUSCH communications associated with the multi-PUSCH CG in accordance with the one or more per-PUSCH uplink transmission parameters.

Some aspects described herein relate to a non-transitory computer-readable medium that stores a set of instructions for wireless communication by a network node. The set of instructions, when executed by one or more processors of the network node, may cause the network node to transmit, to a UE configuration information indicating a configuration for a multi-PUSH CG. The set of instructions, when executed by one or more processors of the network node, may cause the network node to transmit, to the UE, an activation indication for the multi-PUSCH CG, the activation indication indicating one or more per-PUSCH uplink transmission parameters for multiple PUSCH communications associated with the multi-PUSCH CG. The set of instructions, when executed by one or more processors of the network node, may cause the network node to receive, from the UE, the multiple PUSCH communications associated with the multi-PUSCH CG in accordance with the one or more per-PUSCH uplink transmission parameters.

Some aspects described herein relate to an apparatus for wireless communication. The apparatus may include means for receiving, from a network node, configuration information indicating a configuration for a multi-PUSH CG. The apparatus may include means for receiving, from the network node, an activation indication for the multi-PUSCH CG, the activation indication indicating one or more per-PUSCH uplink transmission parameters for multiple PUSCH communications associated with the multi-PUSCH CG. The apparatus may include means for transmitting, to the network node, the multiple PUSCH communications associated with the multi-PUSCH CG in accordance with the one or more per-PUSCH uplink transmission parameters.

Some aspects described herein relate to an apparatus for wireless communication. The apparatus may include means for transmitting, to a UE configuration information indicating a configuration for a multi-PUSH CG. The apparatus may include means for transmitting, to the UE, an activation indication for the multi-PUSCH CG, the activation indication indicating one or more per-PUSCH uplink transmission parameters for multiple PUSCH communications associated with the multi-PUSCH CG. The apparatus may include means for receiving, from the UE, the multiple PUSCH communications associated with the multi-PUSCH CG in accordance with the one or more per-PUSCH uplink transmission parameters.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of uplink configured grant (CG) communication, in accordance with the present disclosure.

FIGS. 5A-5B are diagrams illustrating examples associated with activation indication for multiple physical uplink shared channel (multi-PUSCH) CG, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIGS. 8-9 are diagrams of example apparatuses for wireless communication, in accordance with the present disclosure.

### DETAILED DESCRIPTION

Configured grant (CG) communications may include periodic uplink communications (e.g., physical uplink control channel (PUSCH) communications) that are configured for a user equipment (UE), such that a network node does not need to send separate downlink control information (DCI) to schedule each uplink communication, thereby conserving signaling overhead. A CG, configured for a UE, may be a Type 1 CG that does not require DCI activation, or a Type 2 CG that is activated via DCI activation. In some examples, multiple PUSCH (multi-PUSCH) CG may be supported in new radio (NR) and/or other radio access technologies (RATs). A multi-PUSCH CG is a CG that configures multiple PUSCH communications for a UE in each configured CG period. Multi-PUSCH CG communications may reduce latency for uplink traffic and reduce control signaling overhead associated with scheduling uplink transmissions (e.g., as compared with dynamic uplink grants and/or single-PUSCH CG). Multi-PUSCH CG may be supported for Type 1 CG and Type 2 CG. However, there currently is no standardized way to indicate uplink transmission parameters, such as time domain resource allocation (TDRA), frequency domain resource allocation (FDRA), and modulation and coding scheme (MCS), for multiple PUSCH communications associated with a CG period in the CG activation DCI for Type 2 CG. Without a standardized way to indicate such uplink transmission parameters for multiple PUSCH communications in the CG activation DCI, the UE may not be able to determine the uplink transmission parameters (e.g., TDRA, FDRA, and/or MCS) for the multiple PUSCH communications associated with a multi-PUSCH CG configuration. As a result, the reduced uplink latency and reduced control signaling overhead associated with multi-PUSCH CG communications may not be achieved.

Various aspects relate generally to multi-PUSCH CG communications. Some aspects, more specifically relate to a Type 2 multi-PUSCH CG activation indication (e.g., activation DCI) that indicates per-PUSCH uplink transmission parameters. In some examples, a UE may receive configuration information indicating a configuration for a multi-PUSCH CG. The UE may receive an activation indication (e.g., an activation DCI) indicating one or more per-PUSCH uplink transmission parameters for multiple PUSCH communications associated with the multi-PUSCH CG. The UE may transmit the multiple PUSCH communications associated with the multi-PUSCH CG in accordance with the one or more per-PUSCH uplink transmission parameters indicated by the activation indication. In some examples, the one or more per-PUSCH uplink transmission parameters may include per-PUSCH TDRAs for the multiple PUSCH communications, per-PUSCH FDRAs for the multiple PUSCH communications, and/or per-PUSCH MCSs for the multiple PUSCH communications.

Particular aspects of the subject matter described in this disclosure can be implemented to realize one or more of the following potential advantages. In some examples, the per-PUSCH uplink transmission parameter indications (e.g., for TDRA, FDRA, and/or MCS) in the activation indication for the multi-PUSCH CG are standardized, such that the UE can determine the uplink transmission parameters for multiple PUSCH communications in a CG period. As a result, multi-PUSCH CG communications may be enabled for UEs. By providing standardized indications for the per-PUSCH uplink transmission parameters in the activation indication for a multi-PUSCH CG and enabling multi-PUSCH CG communications for UEs, aspects of the present disclosure may achieve reduced latency for uplink traffic as compared with dynamic uplink grants and/or CG communications configured with a single PUSCH communication in the CG period. Furthermore, by providing standardized indications for the per-PUSCH uplink transmission parameters in the activation indication for a multi-PUSCH CG and enabling multi-PUSCH CG communications for UEs, aspects of the present disclosure may achieve reduced control signaling overhead associated with scheduling uplink transmissions as compared with dynamic uplink grants and/or CG communications configured with a single PUSCH communication in the CG period.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or NR RAT, aspects of the present disclosure can be applied to other RATs, such as a 3G RAT, a 4G RAT, and/or a RAT subsequent to 5G (e.g., 6G).

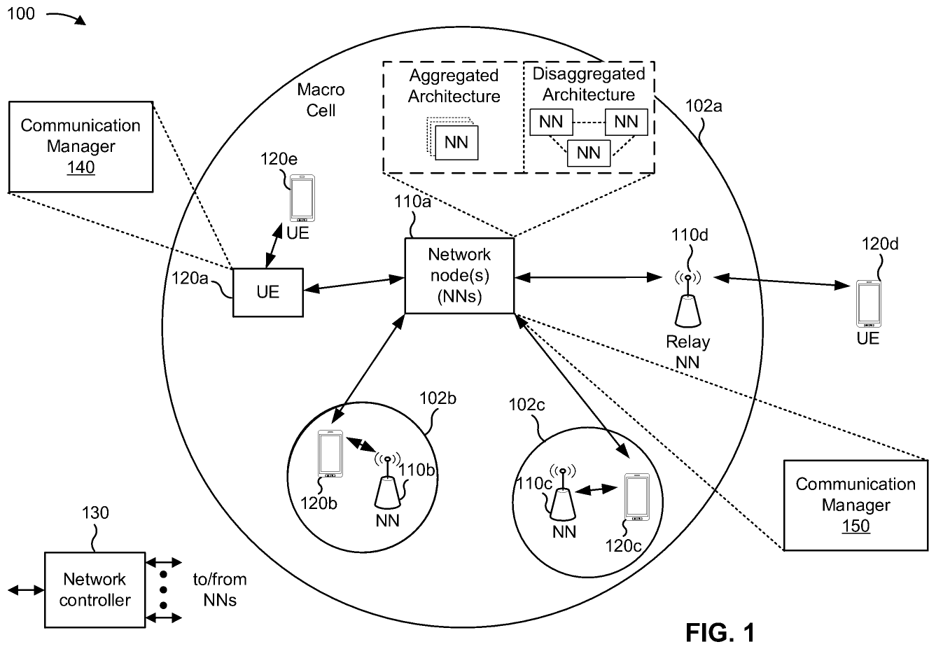

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, configuration information indicating a configuration for a multi-PUSH CG; receive, from the network node, an activation indication for the multi-PUSCH CG, the activation indication indicating one or more per-PUSCH uplink transmission parameters for multiple PUSCH communications associated with the multi-PUSCH CG; and transmit, to the network node, the multiple PUSCH communications associated with the multi-PUSCH CG in accordance with the one or more per-PUSCH uplink transmission parameters. Additionally, or alternatively, the communication manager 140 may perform one or more other operations described herein.

In some aspects, the network node 110 may include a communication manager 150. As described in more detail elsewhere herein, the communication manager 150 may transmit, to a UE configuration information indicating a configuration for a multi-PUSH CG; transmit, to the UE, an activation indication for the multi-PUSCH CG, the activation indication indicating one or more per-PUSCH uplink transmission parameters for multiple PUSCH communications associated with the multi-PUSCH CG; and receive, from the UE, the multiple PUSCH communications associated with the multi-PUSCH CG in accordance with the one or more per-PUSCH uplink transmission parameters. Additionally, or alternatively, the communication manager 150 may perform one or more other operations described herein.

As indicated above, FIG. 1 is provided as an example. Other examples may differ from what is described with regard to FIG. 1.

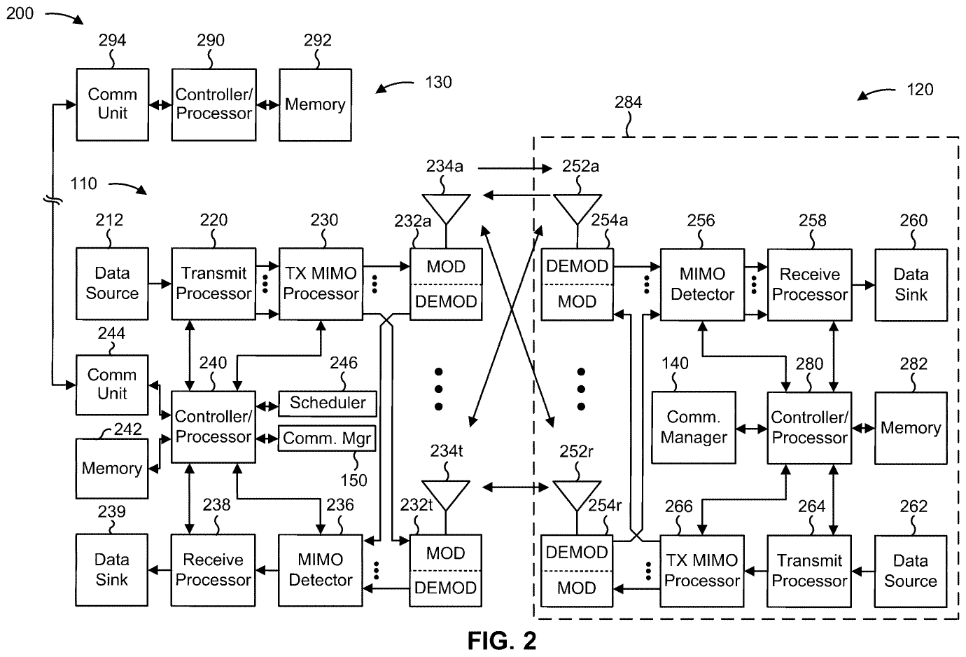

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more MCSs for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

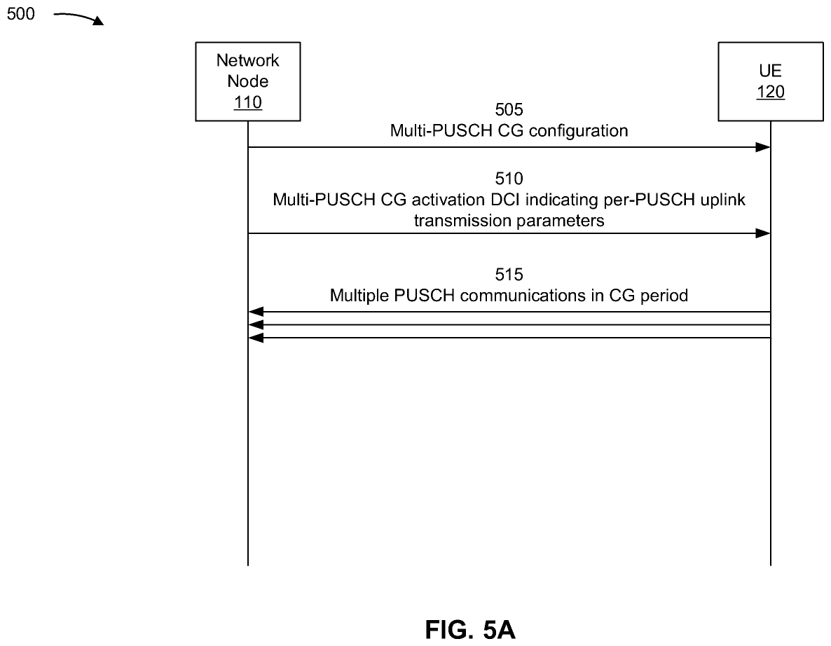

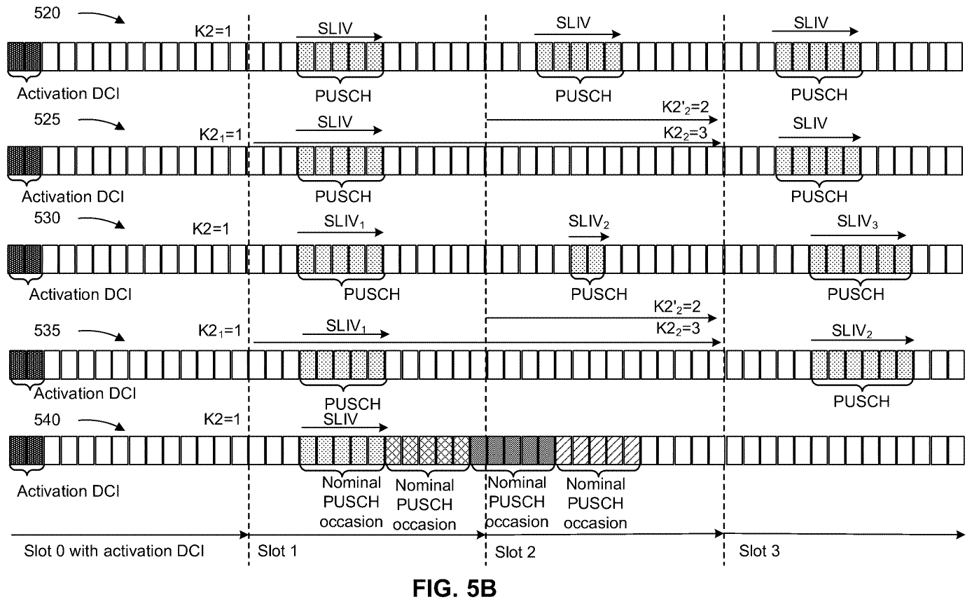

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-5B and 6-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-5B and 6-9).

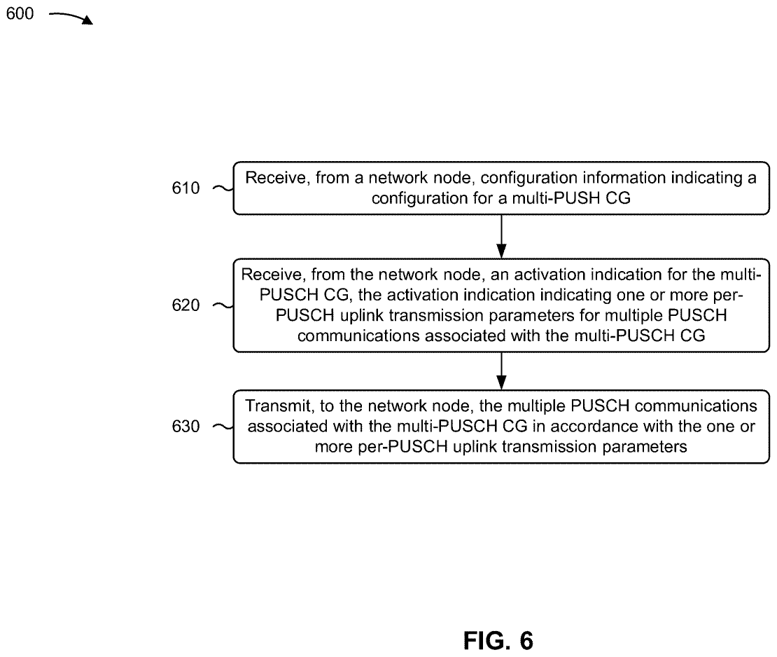

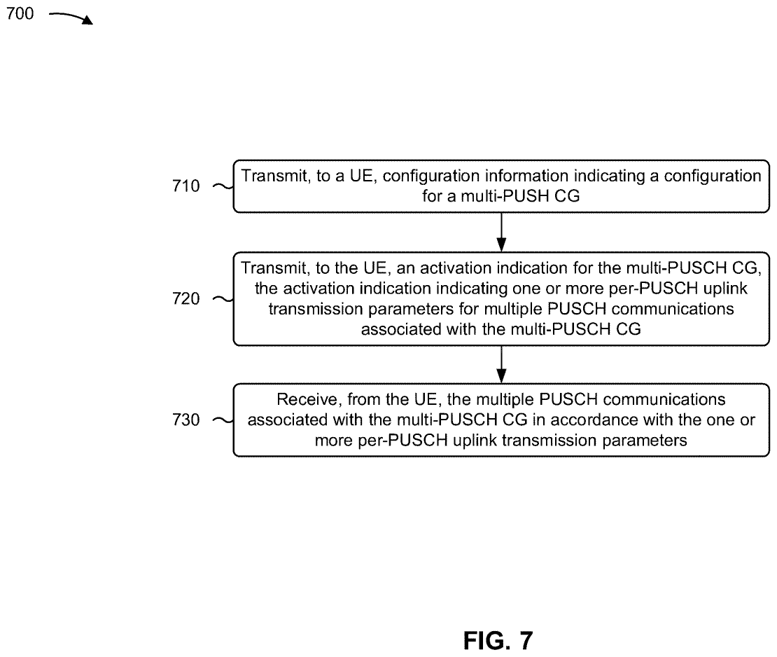

The controller/processor 240 of the network node 110, the controller/processor 280 of the UE 120, and/or any other component(s) of FIG. 2 may perform one or more techniques associated with activation indication for multi-PUSCH CG, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a network node, configuration information indicating a configuration for a multi-PUSH CG; means for receiving, from the network node, an activation indication for the multi-PUSCH CG, the activation indication indicating one or more per-PUSCH uplink transmission parameters for multiple PUSCH communications associated with the multi-PUSCH CG; and/or means for transmitting, to the network node, the multiple PUSCH communications associated with the multi-PUSCH CG in accordance with the one or more per-PUSCH uplink transmission parameters. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a UE configuration information indicating a configuration for a multi-PUSH CG; means for transmitting, to the UE, an activation indication for the multi-PUSCH CG, the activation indication indicating one or more per-PUSCH uplink transmission parameters for multiple PUSCH communications associated with the multi-PUSCH CG; and/or means for receiving, from the UE, the multiple PUSCH communications associated with the multi-PUSCH CG in accordance with the one or more per-PUSCH uplink transmission parameters. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

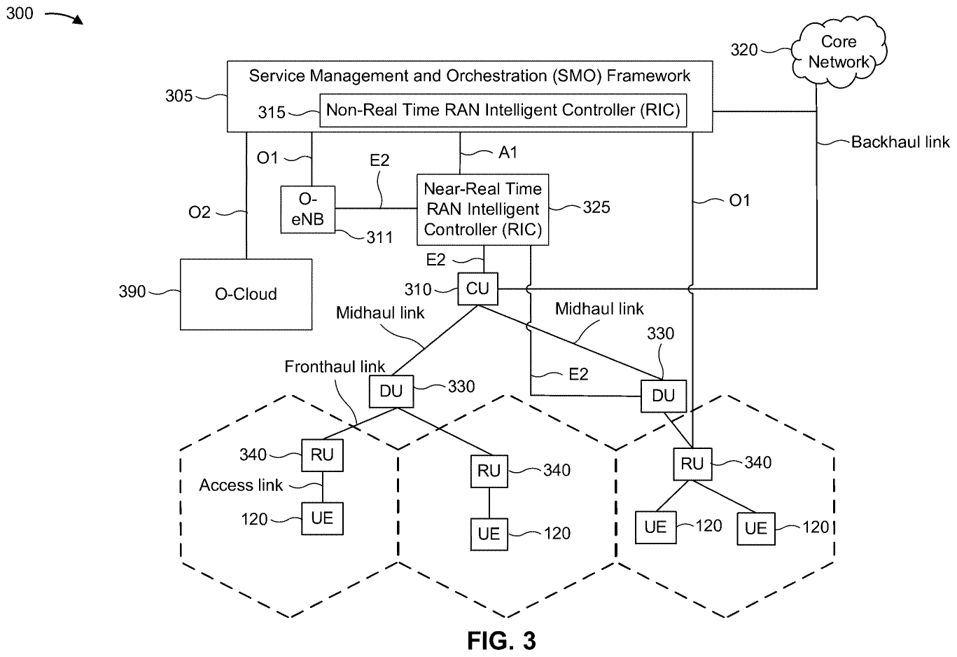

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

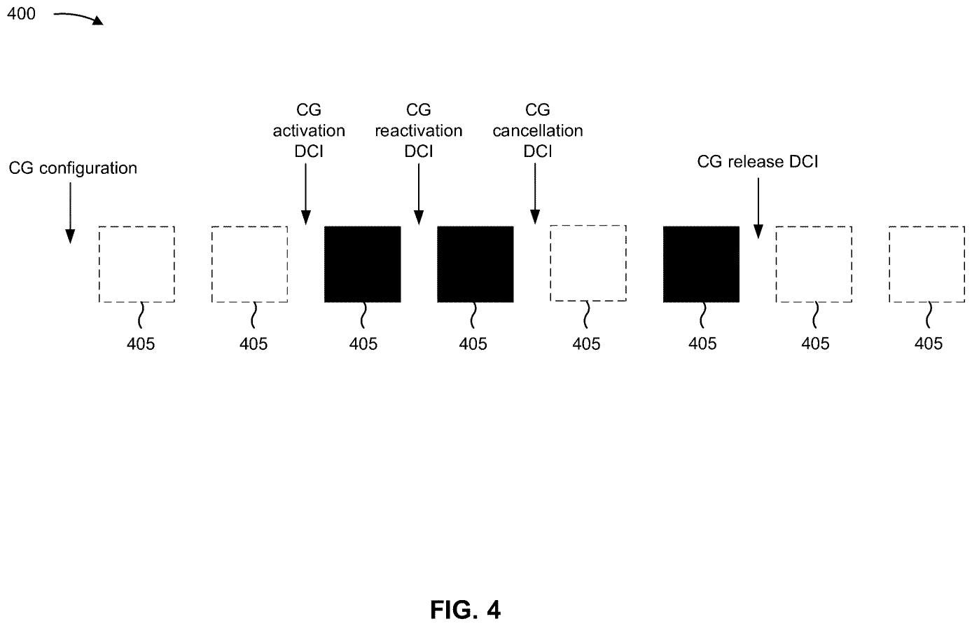

FIG. 4 is a diagram illustrating an example 400 of uplink CG communication, in accordance with the present disclosure. CG communications may include periodic uplink communications (e.g., PUSCH communications) that are configured for a UE, such that the network node does not need to send separate DCI to schedule each uplink communication, thereby conserving signaling overhead.

As shown in example 400, a UE may be configured with a CG configuration for CG communications. For example, the UE may receive the CG configuration via an RRC message transmitted by a network node (e.g., directly to the UE or via one or more network nodes). The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 405 for the UE. That is, the periodicity defines a CG period for the CG configuration, and the CG period includes a CG occasion 405 in which the UE may transmit an uplink communication (e.g., a PUSCH communication). In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The UE may be configured with a type of uplink CG (e.g., Type 1) that does not require DCI activation, or a type of uplink CG (e.g., Type 2) that requires DCI activation. In a case in which the UE is configured with the type of uplink CG that requires DCI activation, the network node may transmit CG activation DCI to the UE (e.g., directly or via one or more network nodes) to activate the CG configuration for the UE. The network node may indicate, in the CG activation DCI, communication parameters, such as an MCS, a resource block (RB) allocation, and/or antenna ports, for the CG PUSCH communications to be transmitted in the scheduled CG occasions 405. The UE may begin transmitting in the CG occasions 405 based at least in part on receiving the CG activation DCI. For example, beginning with a next scheduled CG occasion 405 subsequent to receiving the CG activation DCI, the UE may transmit PUSCH communications in the scheduled CG occasions 405 using the communication parameters indicated in the CG activation DCI. The UE may refrain from transmitting in configured CG occasions 405 prior to receiving the CG activation DCI.

The network node may transmit CG reactivation DCI to the UE (e.g., directly or via one or more network nodes) to change the communication parameters for the CG PUSCH communications. Based at least in part on receiving the CG reactivation DCI, and the UE may begin transmitting in the scheduled CG occasions 405 using the communication parameters indicated in the CG reactivation DCI. For example, beginning with a next scheduled CG occasion 405 subsequent to receiving the CG reactivation DCI, the UE may transmit PUSCH communications in the scheduled CG occasions 405 based at least in part on the communication parameters indicated in the CG reactivation DCI.

In some cases, such as when the network node needs to override a scheduled CG communication for a higher priority communication, the network node may transmit CG cancellation DCI to the UE (e.g., directly or via one or more network nodes) to temporarily cancel or deactivate one or more subsequent CG occasions 405 for the UE. The CG cancellation DCI may deactivate only a subsequent one CG occasion 405 or a subsequent N CG occasions 405 (where N is an integer). CG occasions 405 after the one or more (e.g., N) CG occasions 405 subsequent to the CG cancellation DCI may remain activated. Based at least in part on receiving the CG cancellation DCI, the UE may refrain from transmitting in the one or more (e.g., N) CG occasions 405 subsequent to receiving the CG cancellation DCI. As shown in example 400, the CG cancellation DCI cancels one subsequent CG occasion 405 for the UE. After the CG occasion 405 (or N CG occasions) subsequent to receiving the CG cancellation DCI, the UE may automatically resume transmission in the scheduled CG occasions 405.

The network node may transmit CG release DCI to the UE (e.g., directly or via one or more network nodes) to deactivate the CG configuration for the UE. The UE may stop transmitting in the scheduled CG occasions 405 based at least in part on receiving the CG release DCI. For example, the UE may refrain from transmitting in any scheduled CG occasions 405 until another CG activation DCI is received by the UE. Whereas the CG cancellation DCI may deactivate only a subsequent one CG occasion 405 or a subsequent N CG occasions 405, the CG release DCI deactivates all subsequent CG occasions 405 for a given CG configuration for the UE until the given CG configuration is activated again by a new CG activation DCI.

As indicated above, FIG. 4 is provided as an example. Other examples may differ from what is described with respect to FIG. 4.

In some aspects, multi-PUSCH CG may be supported in NR and/or other RATs. A multi-PUSCH CG is a CG that configures multiple PUSCH communications for a UE in each CG period. That is, in each reoccurring CG occasion configured for a multi-PUSCH CG configuration, a UE may transmit multiple PUSCH communications. Multi-PUSCH CG communications may reduce latency for uplink traffic and reduce control signaling overhead associated with scheduling uplink transmissions (e.g., as compared with dynamic uplink grants and/or single-PUSCH CG). Multi-PUSCH CG may be supported for Type 1 CG (e.g., that does not require DCI activation) and Type 2 CG (e.g., that is activated via DCI activation). However, there currently is no standardized way to indicate uplink transmission parameters, such as TDRA, FDRA, and MCS, for multiple PUSCH communications associated with a CG period in the CG activation DCI for Type 2 CG. Without a standardized way to indicate such uplink transmission parameters for multiple PUSCH communications in the CG activation DCI, the UE may not be able to determine the uplink transmission parameters (e.g., TDRA, FDRA, and/or MCS) for the multiple PUSCH communications associated with a multi-PUSCH CG configuration. As a result, the reduced uplink latency and reduced control signaling overhead associated with multi-PUSCH CG communications may not be achieved.

Some techniques and apparatuses described herein enable a Type 2 multi-PUSCH CG activation indication (e.g., activation DCI) that indicates per-PUSCH uplink transmission parameters. In some aspects, a UE may receive configuration information indicating a configuration for a multi-PUSCH CG. The UE may receive an activation indication (e.g., an activation DCI) indicating one or more per-PUSCH uplink transmission parameters for multiple PUSCH communications associated with the multi-PUSCH CG. The UE may transmit the multiple PUSCH communications associated with the multi-PUSCH CG in accordance with the one or more per-PUSCH uplink transmission parameters indicated by the activation indication. The one or more per-PUSCH uplink transmission parameters may include per-PUSCH TDRAs for the multiple PUSCH communications, per-PUSCH FDRAs for the multiple PUSCH communications, and/or per-PUSCH MCSs for the multiple PUSCH communications. As a result, multi-PUSCH CG communications may be enabled for the UE, which may result in reduced uplink latency and/or reduced control signaling overhead associated with scheduling uplink transmissions.

FIGS. 5A-5B are diagrams illustrating examples associated with activation indication for multi-PUSCH CG, in accordance with the present disclosure. As shown in FIG. 5A, example 500 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 5A, and by reference number 505, the network node 110 may transmit, and the UE 120 may receive, configuration information indicating a configuration for a multi-PUSCH CG (e.g., a multi-PUSCH CG configuration). In some aspects, the configuration information may be included in an RRC message or multiple RRC messages. The multi-PUSCH CG configuration may indicate a periodicity that defines a CG period associated with the multi-PUSCH CG. The multi-PUSCH CG may be a CG that configures multiple PUSCH communications (e.g., multiple PUSCH transmission opportunities) for the UE 120 in each CG period configured for the multi-PUSCH CG. That is, a CG occasion, in each CG period associated with the multi-PUSCH CG, may include multiple PUSCH communications scheduled/allocated for the UE 120. In some aspects, the multi-PUSCH CG may be a Type 2 CG that is activated via an activation indication, such as an activation DCI. In some aspects, the configuration information may include configurations for multiple CGs, such as multiple multi-PUSCH CGs.

In some aspects, the configuration information may include an indication of a quantity (N) of PUSCH communications associated with the multi-PUSCH CG (e.g., a quantity of PUSCH communications configured in the CG period). In some aspects, the quantity of PUSCH communications may be configured per CG configuration. For example, the configuration for each multi-PUSCH CG may indicate a value of N for that multi-PUSCH CG. In some aspects, the quantity of PUSCH communications may be a value of N configured for all CG configurations.

In some aspects, the configuration information may include a mapping between index values and respective sets of TDRA parameters that indicate per-PUSCH TDRAs for multiple PUSCH communications associated with the multi-PUSCH CG. For example, the configuration information may configure a TDRA table including a plurality of rows, with each row corresponding to a respective row index and each row indicating a respective set of TDRA parameters. In some examples, the value of N (e.g., the quantity of the PUSCH communications) may be configured per row index. That is, different rows of the TDRA table may indicate sets of TDRA parameters for different quantities of PUSCH communications. In some aspects, the configuration information may include a mapping between index values and respective sets of FDRA parameters for multiple PUSCH communications associated with the multi-PUSCH CG. For example, the configuration information may configure an FDRA adjustment table including a plurality of rows, with each corresponding to a respective row index and each indicating a respective set of FDRA adjustments for PUSCH communications (e.g., from a first FDRA value indicated in an FDRA field of an activation indication). In some aspects, the configuration information may include a mapping between index values and respective sets of MCS parameters for multiple PUSCH communications associated with the multi-PUSCH CG. For example, the configuration information may configure an MCS table (or a delta MCS table) including a plurality of rows, with each corresponding to a respective row index and each indicating a respective set of MCS parameters (e.g., MCS values and/or delta MCS values) for PUSCH communications. In some aspects, the configuration information that configures the TDRA table, the FDRA adjustment table, and/or the MCS table may be included in one or more separate RRC messages from the multi-PUSCH CG configuration. In some other aspects, the configuration information that configures the TDRA table, the FDRA adjustment table, and/or the MCS table may be included in a same RRC message as the multi-PUSCH CG configuration.

As further shown in FIG. 5A, and by reference number 510, the network node 110 may transmit, and the UE 120 may receive, an activation indication for the multi-PUSCH CG. For example, the activation indication may be an activation DCI (e.g., a type 2 multi-PUSCH CG activation DCI). The activation indication (e.g., the activation DCI) may indicate per-PUSCH uplink transmission parameters for multiple PUSCH communications associated with the multi-PUSCH CG (e.g., multiple PUSCH communications scheduled/allocated for the UE 120 in a CG period associated with the multi-PUSCH CG). The per-PUSCH uplink transmission parameters may identify respective transmission parameters to be used by the UE 120 for transmission of each PUSCH communication of the multiple PUSCH communications scheduled/allocated in the CG period associated with the multi-PUSCH CG. In some aspects, the per-PUSCH uplink transmission parameters may include per-PUSCH TDRAs, per PUSCH FDRAs, and/or per-PUSCH MCSs. The per-PUSCH uplink transmission parameters may be indicated, in the activation indication (e.g., the activation DCI) using indications of respective parameters for the multiple PUSCH communications, indications of common parameters that are applied to all of the multiple PUSCH communications, or a combination thereof.

In some aspects, the multiple PUSCH communications associated with the multi-PUSCH CG may include a quantity (N) of PUSCH communications scheduled in respective slots (e.g., scheduled in N slots) in the CG period. In some examples, the N slots in which the N PUSCH communications are scheduled may be N consecutive slots, starting from a first slot associated with a first PUSCH communication. In this case, in which the multiple PUSCH communications are scheduled in respective consecutive slots, the multiple PUSCH communications may be referred to a “continuous PUSCHs.” In some other examples, the N slots in which the N PUSCH communications are scheduled may include non-consecutive slots, and the multiple PUSCH communications may be referred to as “non-continuous PUSCHs.” In some examples, a single start and length indicator value (SLIV) may be applied to all of the N PUSCH communications. The SLIV indicates a starting symbol in a slot and an allocation length (e.g., a number of symbols) for a PUSCH allocation. In some other examples, the NPUSCH communications may be allocated with multiple SLIVs (e.g., different SLIVs may be indicated for different PUSCH communications).

In some aspects, a value indicated in a TDRA field of the activation indication may indicate the per-PUSCH TDRAs for the N PUSH communications scheduled in the N slots. The activation indication may include, in the TDRA field, an indication of a row index associated with a row of a configured TDRA table (e.g., indicated in the configuration information). For example, a value m in the TDRA field of the activation indication may indicate a row index m+1 associated with a row of the TDRA table, and the row of the TDRA table may indicate the TDRAs for the NPUSCH communications. In some aspects, the row associated with the indicated row index may indicate a SLIV (or separate starting symbol and allocation length indications) that is to be applied for all of the NPUSCH communications (e.g., a single SLIV indication that applies to all of the N PUSCH communications). In this case, the row may also indicate a PUSCH mapping type (e.g., PUSCH mapping type A (slot-based) or PUSCH mapping type B (sub-slot based)) that is to be applied for all of the NPUSCH communications.

In one example, in which the NPUSCH communications are scheduled in N consecutive slots (e.g., the NPUSCH communications are continuous PUSCHs), the row may further indicate a slot offset (K2) for a first slot associated with a first PUSCH communication of the NPUSCH communications. In this case, the UE 120 may identify the TDRAs for N PUSCH communications by applying the indicated SLIV in N consecutive slots starting with the first slot indicated by the slot offset (K2). FIG. 5B shows an example 520 of TDRAs for continuous PUSCHs with the same SLIV. As shown in example 520, the activation DCI may be received in a first two symbols of slot 0. The slot offset of K2=1 indicates that a first PUSCH communication is scheduled in slot 1 (e.g., a next slot from slot 0, in which the activation DCI is received). A second PUSCH communication and a third PUSCH communication are scheduled in slot 2 and slot 3, respectively, and the same SLIV is used for the first PUSCH communication (in slot 1), the second PUSCH communication (in slot 2), and the third PUSCH communication (in slot 3).

In another example, the row may further indicate (e.g., in addition to the SLIV and the PUSCH mapping type) a respective slot offset (K2ₙ) for each of the NPUSCH communications. In this case, the row may include indications of N slot offsets (K2ₙ), and the nth PUSCH communication has a slot offset of K2ₙ, n=0, . . . , N−1. The slot offset K2ₙ may indicate may indicate an offset between the slot in which the activation indication is received and the slot in which the nth PUSCH communication is scheduled. The indication of the respective slot offsets for the N PUSCH communications may be used to indicate TDRAs for non-continuous PUSCHs (or for continuous PUSCHs). FIG. 5B shows an example 525 of TDRAs for non-continuous PUSCHs with a same SLIV. As shown in example 525, a first slot offset of K2₁=1 indicates that a first PUSCH communication is scheduled in slot 1, a second slot offset of K2₂=3 indicates that a second PUSCH communication is scheduled in slot 3, and the same SLIV is used for the first PUSCH communication (in slot 1) and the second PUSCH communication (in slot 3).

In another example, the row may further indicate (e.g., in addition to the SLIV and the PUSCH mapping type) a slot offset (K2) for a first PUSCH communication of the NPUSCH communications and a respective relative slot offset (K2ₙ′) for each of remaining PUSCH communication (e.g., other than the first PUSCH communication) of the N PUSCH communications. In this case, the row may include an indication of one slot offset (K2) and indications of N−1 relative slot offsets (K2ₙ′) for the remaining N−1 PUSCH communications. The slot offset (K2) may indicate an offset between the slot in which the activation indication is received and the first slot associated with the first PUSCH communication, and each relative slot offset (K2ₙ′) may indicate an offset between the first slot and the nth slot associated with the nth PUSCH communication. For example, the nth PUSCH communication may have a slot offset (from the slot in which the activation indication is received) of K2+K2ₙ′. Alternatively, each relative slot offset (K2ₙ′) may indicate an offset between the n−1th slot associated with the n−1th PUSCH communication and the nth slot associated with the nth PUSCH communication. As further shown in example 525 of FIG. 5B, a relative slot offset of K2₂′=2 for the second PUSCH communication indicates the relative slot offset between the slot in which the first PUSCH communication is scheduled (slot 1) and the slot in which the second PUSCH communication is scheduled (slot 3). The indication of the slot offset for the first PUSCH communication and the respective relative slot offsets for the remaining N−1 PUSCH communications may be used to indicate TDRAs for non-continuous PUSCHs (or for continuous PUCHs).

In another example, in a case in which the row indicates the SLIV to be applied to all of the N PUSCH communications, the activation indication may further indicate a bitmap that identifies the N slots in which the N PUSCH communications are scheduled (e.g., with the same SLIV applied in each of the N slots). The bitmap may include a plurality of bits, with each bit corresponding to a respective slot of a plurality of slots (e.g., a plurality of slots subsequent to the slot in which the activation indication is received). The value of each bit in the bitmap indicates whether the respective slot us scheduled with a PUSCH communication. For example, a first value (e.g., 1) for a bit indicates that the respective slot corresponding to that bit is scheduled with a PUSCH communication, and a second value (e.g., 0) for a bit indicates that the respective slot corresponding to that bit is not scheduled with a PUSCH communication. In some examples, the activation indication (e.g., the activation DCI) may include (e.g., in a DCI field other than the TDRA field) an indication of the bitmap. In some other examples, the row associated with the row index indicated in the TDRA field of the activation indication may include an indication of the bitmap.

In some aspects, in a case in which NPUSCH communications are scheduled in N respective slots (e.g., with the same SLIV applied for the NPUSCH communications), the value of N may be configured via RRC signaling. For example, the value of N may be indicated in the configuration information. In some examples, the value of N may be configured per multi-PUSCH CG configuration. For example, the configuration for the multi-PUSCH CG may include an indication of the value of N (e.g., the quantity of PUSCH communications) configured for the multi-PUSCH CG. In some other example, the value of N may be a common value configured for multiple multi-PUSCH CG configurations (e.g., for all multi-PUSCH CG configurations).

In some aspects, in a case in which N PUSCH communications are scheduled in N respective slots (e.g., with the same SLIV applied for the NPUSCH communications), the activation indication may indicate the value of N. In some examples, the activation indication may include an explicit indication of the value of N (e.g., in a field other than the TDRA field). In some examples, the value of N may be configured per row index of the configured TDRA table. In this case, the indication of the row index in the TDRA field of the activation indication may provide an indication of the value of N to the UE 120. For example, the row associated with the row index may include an explicit indication of the value of Nor may include information that indicates (e.g., implicitly indicates) the value of N to the UE 120. In one example, in which the NPUSCH communications are scheduled in N consecutive slots (e.g., the N PUSCH communications are continuous PUSCHs), the row may further indicate (e.g., in addition to the SLIV and the PUSCH mapping type), the slot offset (K2) for the first slot associated with a first PUSCH communication and the value of N (e.g., the quantity of PUSCH communications), such that the NPUSCH communications are scheduled in N consecutive slots starting from the first slot. In another example, in which the row indicates a respective slot offset (K2ₙ) for each of the N PUSCH communications, the number of the N slot offsets (K2ₙ) indicated in the row may provide an indication of the value of N. In another example, in which the row indicates a slot offset (K2) for a first PUSCH communication and a respective relative slot offset (K2ₙ′) for each of the N−1 remaining PUSCH communications, the number of the N−1 relative slot offsets (K2ₙ′) indicated in the row may provide an indication of the value of N. In another example, in which the activation indication indicates the bitmap, the number of bits that indicate a PUSCH scheduled in the respective slots may provide an indication of the value of N. In this case, the bitmap length may be configured per row index of the configured TDRA table. In another example, the TDRA field of the activation indication may indicate (e.g., via an explicit indication or an indication by the row associated with an indicated row index) the slot offset (K2) for the first slot associated with the first PUSCH communication, and another field of the activation indication may indicate N−1 slot offset values (or relative slot offset values) for the remaining N−1 PUSCH communications other than the first PUSCH communication. In this case, the number of the N−1 slot offset values (or relative slot offset values) indicated in the other field of the activation indication may provide the indication of the value of N.

In some aspects, the multiple PUSCH communications associated with the multi-PUSCH CG may include a number (M) of consecutive PUSCH communications scheduled in each of a number (N) of slots in the CG period. In this case, the SLIV indicated by the activation indication (e.g., indicated by the row associated with the row index indicated in the TDRA field of the activation indication, or indicated by an explicit indication of the SLIV in the activation indication) may apply to the a first PUSCH communication of the M consecutive PUSCH communications scheduled in each of the N slots. In some examples, the value of M (e.g., the number of PUSCH communications scheduled in each slot) may be indicated by the activation indication or indicated in the configuration information (e.g., configured per multi-PUSCH configuration or common to multiple multi-PUSCH configurations).

In some aspects, the multiple PUSCH communications associated with the multi-PUSCH CG may include a quantity (N) of PUSCH communications scheduled in respective slots (e.g., scheduled in N slots) in the CG period, and different SLIVs may be allocated for different PUSCH communications of the NPUSCH communications. In this case, the activation indication may indicate, in the TDRA field, a row index (e.g., a value m in the TDRA field may indicate a row index m+1) associated with a row of a configured TDRA table, and the row of the TDRA table may indicate a respective SLIV for each of the NPUSCH communications and a respective PUSCH mapping type for each of the N PUSCH communications. For example, the row may include N SLIV indications and NPUSCH mapping type indications. The TDRA table may be indicated in the configuration information via RRC signaling (e.g., in pisch-TimeDomainAllocationListForMultiPUSCH).

In one example, in which the N PUSCH communications are scheduled in N consecutive slots (e.g., the NPUSCH communications are continuous PUSCHs), the row may further indicate (e.g., in addition to N SLIVs for the N PUSCH communications) a slot offset (K2) for a first slot associated with a first PUSCH communication of the N PUSCH communications. The slot offset (K2) may indicate an offset between a slot in which the activation indication is received and the first slot associated with the first PUSCH communication. In this case, the UE 120 may identify the first slot of the N consecutive slots in which the N PUSCH communications are scheduled based on the slot offset, and each of the N PUSCH communications may be scheduled within a respective slot of the N consecutive slots based on a respective SLIV of the N SLIVs. FIG. 5B shows an example 530 of TDRAs for continuous PUSCHs with different SLIVs. As shown in example 530, the activation DCI may be received in a first two symbols of slot 0. The slot offset of K2=1 indicates that a first PUSCH communication is scheduled in slot 1 (e.g., a next slot from slot 0, in which the activation DCI is received). A second PUSCH communication and a third PUSCH communication are scheduled in slot 2 and slot 3, respectively. The first PUSCH communication is scheduled in slot 1 in accordance with a first SLIV (SLIV₁), the second PUSCH communication is scheduled in slot 2 in accordance with a second SLIV (SLIV₂), and the third PUSCH communication is scheduled in slot 2 in accordance with a third SLIV (SLIV₃).

In another example, the row may further indicate (e.g., in addition to the N SLIVs for the NPUSCH communications) a respective slot offset (K2ₙ) for each of the N PUSCH communications. In this case, the row may include indications of N slot offsets (K2ₙ), and the nth PUSCH communication has a slot offset of K2ₙ, n=0, . . . , N−1. The slot offset K2ₙ may indicate may indicate an offset between the slot in which the activation indication is received and the slot in which the nth PUSCH communication is scheduled. The indication of the respective slot offsets and the respective SLIVs for the N PUSCH communications may be used to indicate TDRAs for non-continuous PUSCHs (or for continuous PUCHs). FIG. 5B shows an example 535 of TDRAs for non-continuous PUSCHs with different SLIVs. As shown in example 525, a first slot offset of K2₁=1 indicates that a first PUSCH communication is scheduled in slot 1, and a second slot offset of K2₂=3 indicates that a second PUSCH communication is scheduled in slot 3. The first PUSCH communication is scheduled in slot 1 in accordance with a first SLIV (SLIV₁), and the second PUSCH communication is scheduled in slot 3 in accordance with a second SLIV (SLIV₂).

In another example, the row may further indicate (e.g., in addition to the N SLIVs for the NPUSCH communications) a slot offset (K2) for a first PUSCH communication of the N PUSCH communications and a respective relative slot offset (K2ₙ′) for each of remaining PUSCH communication (e.g., other than the first PUSCH communication) of the N PUSCH communications. In this case, the row may include an indication of one slot offset (K2) and indications of N−1 relative slot offsets (K2ₙ′) for the remaining N−1 PUSCH communications. The slot offset (K2) may indicate an offset between the slot in which the activation indication is received and the first slot associated with the first PUSCH communication, and each relative slot offset (K2ₙ′) may indicate an offset between the first slot and the nth slot associated with the nth PUSCH communication. For example, the nth PUSCH communication may have a slot offset (from the slot in which the activation indication is received) of K2+K2ₙ′. Alternatively, each relative slot offset (K2ₙ′) may indicate an offset between the n−1th slot associated with the n−1th PUSCH communication and the nth slot associated with the nth PUSCH communication. As further shown in example 535 of FIG. 5B, a relative slot offset of K2₂′=2 for the second PUSCH communication indicates the relative slot offset between the slot (slot 1) in which the first PUSCH communication is scheduled in accordance with SLIV₁ and the slot (slot 3) in which the second PUSCH communication is scheduled in accordance with SLIV₂.

In some aspects, in a case in which the N PUSCH communications associated with the multi-PUSCH CG are scheduled in N respective slots in accordance with N respective SLIVs, the activation indication (e.g., the activation DCI) may indicate the value of N. For example, the number of the valid SLIV values indicated in the row (e.g., the row associated with the row index indicated in the TDRA field of the activation indication) may provide an indication of the value of N (e.g., the quantity of the multiple PUSCH communications associated with the multi-PUSCH CG). In some other aspects, in case in which the NPUSCH communications associated with the multi-PUSCH CG are scheduled in N respective slots in accordance with N respective SLIVs, the value of N may be indicated in the configuration information (e.g., configured per multi-PUSCH CG configuration, or common for multiple multi-PUSCH CG configurations).

In some aspects, the multiple PUSCH communications associated with the multi-PUSCH CG may include a quantity (N) of PUSCH communications scheduled in respective nominal PUSCH occasions (e.g., N nominal PUSCH occasions) in the CG period. FIG. 5B shows an example 540 of TDRAs for PUSCH communications scheduled in respective consecutive nominal PUSCH occasions in a CG period. As shown in example 540, the nominal PUSCH occasions are consecutive allocations of symbols for PUSCH transmissions. In some examples, a nominal PUSCH occasion may begin in a same slot as a previous nominal PUSCH occasion. In some examples, a nominal PUSCH occasion may include symbols in different slots (e.g., a nominal PUSCH occasion may cross a slot boundary).

In some aspects, in a case in which the NPUSCH communications associated with the multi-PUSCH CG are scheduled in N consecutive nominal PUSCH occasions, the activation indication may indicate, in the TDRA field, a row index (e.g., a value m in the TDRA field may indicate a row index m+1) associated with a row of a configured TDRA table (e.g., indicated in the configuration information), and the row of the TDRA table may indicate a slot offset (K2) for a first slot associated with a first nominal PUSCH occasion, a SLIV indicating a start symbol (S) and an allocation length (L) (or separate indications of S and L), and a PUSCH mapping type. The SLIV and the PUSCH mapping type may apply to the NPUSCH communications. The start symbol (S) may indicate a start symbol for the first nominal PUSCH occasion of the N consecutive nominal PUSCH occasions, and the allocation length (L) may be an allocation length applied to each of the N nominal PUSCH occasions. The slot offset (K2) indicates the first slot in which the first PUSCH occasion is scheduled. As further shown in example 540, the slot offset of (K2=1) indicates that the first nominal PUSCH occasion is scheduled in slot 1. The UE 120 may determine the starting slot, starting symbol, ending slot, and ending symbol for each of the N nominal PUSCH occasions based at least in part on the first slot (Kₛ) associated with the first nominal PUSCH occasion (e.g., the slot in which the first PUSCH communication is scheduled), the start symbol (S), the allocation length (L), an a number of symbols per slot

$$( {N}_{symb}^{slot} ) .$$

For example, for the nth nominal PUSCH occasion, n=0, . . . , N−1, the starting slot (e.g., the slot in which the nominal PUSCH occasion starts) may be given by

$${K}_{s} + ⌊ \frac{S + n \cdot L}{{N}_{symb}^{slot}} ⌋ ,$$

the starting symbol relative to the start of the starting slot may be given by

$$mod ( S + n \cdot L , {N}_{symb}^{slot} ) ,$$

the ending slot (e.g., the slot in which the nominal PUSCH occasion ends) may be given by

$${K}_{s} + ⌊ \frac{S + ( n + 1 ) \cdot L - 1}{{N}_{symb}^{slot}} ⌋ ,$$

and the ending symbol relative to the start of the ending slot may be given by

$$mod ( S + ( n + 1 ) \cdot L - 1 , {N}_{symb}^{slot} ) .$$

In some aspects, in a case in which the N PUSCH communications associated with the multi-PUSCH CG are scheduled in N consecutive nominal PUSCH occasions, the value of N may be indicated (e.g., via RRC signaling) in the configuration information. For example, the value of N may be configured per multi-PUSCH CG configuration or may be configured as a common value for multiple multi-PUSCH CG configurations (e.g., for all multi-PUSCH CG configurations). In some other aspects, in a case in which the NPUSCH communications associated with the multi-PUSCH CG are scheduled in N consecutive nominal PUSCH occasions, the value of N may be indicated by the activation indication (e.g., the activation DCI). In some examples, the activation indication may include an explicit indication of the value of N (e.g., in a field other than the TDRA field). In some examples, the value of N may be configured per row index of the configured TDRA table. In this case, the indication of the row index in the TDRA field of the activation indication may provide an indication of the value of N to the UE 120.

In some aspects, the activation indication may indicate per-PUSCH FDRAs for the multiple PUSCH communications associated with the multi-PUSCH CG (e.g., for N PUSCH communications scheduled in respective slots or nominal PUSCH occasions in the CG period). In one example, the activation indication may indicate, in an FDRA field, an FDRA (e.g., a single FDRA) that applies the all of the NPUSCH communications. In another example, the activation indication may include multiple FDRA fields (e.g., NFDRA fields), and each FDRA field, of the multiple FDRA fields, may indicate an FDRA for a respective PUSCH communication of the multiple PUSCH communications. In this case, the N FDRA fields may be mapped to the N PUSCH communications one-to-one, for n=0, . . . , N−1. In some examples, the N FDRA fields may be of equal length, and each FDRA field may include a respective FDRA type indication (e.g., 0, 1, or 2). In this case, different FDRA types may be used for different PUSCH communications. In some other examples, a first FDRA field (n=0) of the N FDRA fields may have a first length and may include an FDRA type indication (e.g., 0, 1, or 2), and the remaining FDRA fields (from n=0 to n=N−1) may have a second length that is smaller than the first length. In this case, the FDRA type indication included in the first FDRA field may be applied for the remaining FDRA fields, and the remaining FDRA fields may not include bits for indicating the FDRA type resulting in a reduced length as compared to the first FDRA field.

In another example, the activation indication may include an FDRA field that indicates an FDRA for the first PUSCH communication of the N PUSCH communications, and the activation indication may include a respective FDRA adjustment field for each remaining PUSCH communication (other than the first PUSCH communication) of the N PUSCH communications. For example, the activation indication may include N−1 FDRA adjustment fields. The respective FDRA adjustment field, for each remaining PUSCH communication, may indicate an FDRA adjustment to the FDRA indicated in the FDRA field to be applied for that PUSCH communication. For example, the FDRA adjustment indicated in the nth FDRA adjustment field is applied to the FDRA indicated in the FDRA field for the nth PUSCH communication, n=1, . . . , N−1. In some examples, each FDRA adjustment field may have a shorter length than the FDRA field. The FDRA adjustment may be to modify the allocated RBs for a PUSCH communication. For example, the FDRA adjustment may include at least one of scaling RB numbers, increasing RB numbers, reducing RB numbers, frequency hopping, or uplink cancellation, among other examples.

In another example, the activation indication may include an FDRA field and an FDRA adjustment field. The FDRA field may indicate an FDRA for a first PUSCH communication of the N PUSCH communications. The FDRA adjustment field may indicate N−1 FDRA adjustments for the remaining PUSCH communications (other than the first PUSCH communication). For example, the FDRA adjustment field may indicate a row index associated with a row of a configured FDRA adjustment table (e.g., indicated in the configuration information), and the row may indicate a respective FDRA adjustment for each of the N−1 remaining PUSCH communications (other than the first PUSCH communication). That is, the row may indicate N−1 FDRA adjustments, and the nth FDRA adjustment is applied to the FDRA indicated in the FDRA field for the nth PUSCH communication, n=1, . . . , N−1.

In some aspects, the activation indication may indicate per-PUSCH MCSs for the multiple PUSCH communications associated with the multi-PUSCH CG (e.g., for N PUSCH communications scheduled in respective slots or nominal PUSCH occasions in the CG period). In one example, the activation indication may indicate, in an MCS field, an MCS (e.g., a single MCS) that applies the all of the NPUSCH communications. In another example, the activation indication may include multiple MCS fields (e.g., N MCS fields), and each MCS field, of the multiple MCS fields, may indicate an MCS for a respective PUSCH communication of the multiple PUSCH communications. In this case, the N MCS fields may be mapped to the N PUSCH communications one-to-one, for n=0, . . . , N−1. In some examples, the N MCS fields may be of equal length.

In another example, the activation indication may include an MCS field that indicates an MCS (e.g., an MCS index) for the first PUSCH communication of the N PUSCH communications, and the activation indication may include a respective delta MCS field for each remaining PUSCH communication (other than the first PUSCH communication) of the N PUSCH communications. For example, the activation indication may include N−1 delta MCS fields. The respective delta MCS field, for each remaining PUSCH communication, may indicate a delta MCS (e.g., a delta value to be added to the MCS index indicated in the MCS field) to determine the MCS for that PUSCH communication. For example, the delta MCS indicated in the nth delta MCS field is added to the MCS index indicated in the MCS field to determine the MCS for the nth PUSCH communication, n=1, . . . , N−1. In some examples, each delta MCS field may have a shorter length than the MCS field.

In another example, the activation indication may include an MCS field and a delta MCS field. The MCS field may indicate an MCS (e.g., an MCS index) for a first PUSCH communication of the N PUSCH communications. The delta MCS field may indicate N−1 delta MCSs for the remaining PUSCH communications (other than the first PUSCH communication). For example, the delta MCS field may indicate a row index associated with a row of a configured delta MCS table (e.g., indicated in the configuration information), and the row may indicate a respective delta MCS for each of the N−1 remaining PUSCH communications (other than the first PUSCH communication). That is, the row may indicate N−1 delta MCSs, and the nth delta MCS is added to the MCS index indicated in the MCS field to determine the MCS for the nth PUSCH communication, n=1, . . . , N−1.

In another example, the activation indication may include, in an MCS field, an indication that maps to N respective MCSs (e.g., N respective MCS indexes) for the N PUSCH communications. For example, the activation indication may include, in the MCS field, an indication of a row index associated with a row of a configured MCS table (e.g., indicated in the configuration information), and the row may indicate a respective MCS (e.g., a respective MCS index) for each of the N PUSCH communications. That is, the row may indicate N MCS indexes, and the nth MCS index may be applied for the nth PUSCH communication, n=0, . . . , N−1.

In another example, the activation indication may include, in an MCS field, an indication that maps to an MCS for a first PUSCH communication of the NPUSCH communications and N−1 respective delta MCSs for the N−1 remaining PUSCH communications (other than the first PUSCH communication). For example, the activation indication may include, in the MCS field, an indication of a row index associated with a row of a configured MCS table (e.g., indicated in the configuration information), and the row may indicate an MCS (e.g., an MCS index) for the first PUSCH communication and a respective delta MCS for each of the N−1 remaining PUSCH communications (other than the first PUSCH communication). That is, the row may indicate the MCS index and N−1 delta MCSs, and the nth delta MCS may be added to the MCS index to determine the MCS for the nth PUSCH communication, n=1, . . . , N−1.

As further shown in FIG. 5A, and by reference number 515, the UE 120 may transmit the multiple PUSCH communications associated with the multi-PUSCH CG (e.g., multiple PUSCH communications in the CG period associated with the multi-PUSCH CG) in accordance with the one or more per-PUSCH uplink transmission parameters indicated by the activation indication (e.g., the activation DCI) for the multiple PUSCH communications. For example, the UE 120 may transmit the multiple PUSCH communications in accordance with the per-PUSCH TDRAs, the per-PUSCH FDRAs, and/or the per-PUSCH MCSs indicated by the activation indication. The network node 110 may receive the multiple PUSCH communications associated with the multi-PUSCH CG (e.g., the multiple PUSCH communications transmitted by the UE 120 in the CG period) in accordance with the one or more per-PUSCH uplink transmission parameters (e.g., the per-PUSCH TDRAs, the per-PUSCH FDRAs, and/or the per-PUSCH MCSs) indicated by the activation indication for the multiple PUSCH communications.

As indicated above, FIGS. 5A-5B are provided as examples. Other examples may differ from what is described with respect to FIGS. 5A-5B.

FIG. 6 is a diagram illustrating an example process 600 performed, for example, by a UE, in accordance with the present disclosure. Example process 600 is an example where the UE (e.g., UE 120) performs operations associated with activation indication for multi-PUSCH CG.

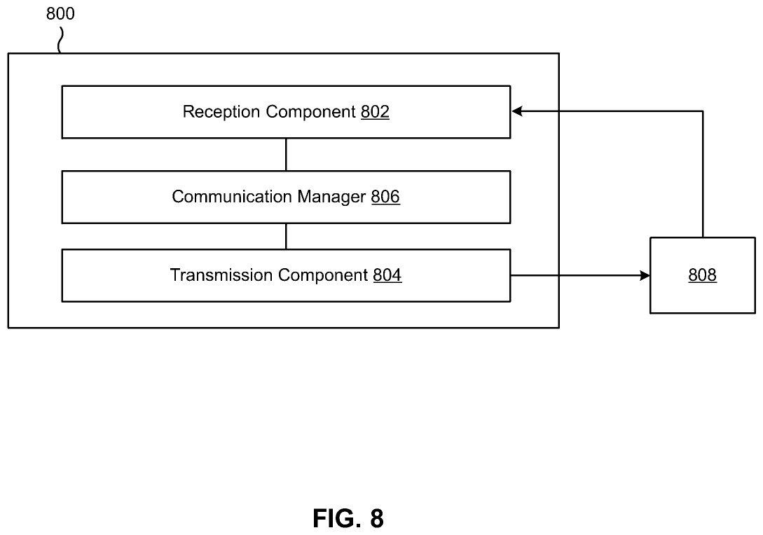

As shown in FIG. 6, in some aspects, process 600 may include receiving, from a network node, configuration information indicating a configuration for a multi-PUSH CG (block 610). For example, the UE (e.g., using reception component 802 and/or communication manager 806, depicted in FIG. 8) may receive, from a network node, configuration information indicating a configuration for a multi-PUSH CG, as described above.

As further shown in FIG. 6, in some aspects, process 600 may include receiving, from the network node, an activation indication for the multi-PUSCH CG, the activation indication indicating one or more per-PUSCH uplink transmission parameters for multiple PUSCH communications associated with the multi-PUSCH CG (block 620). For example, the UE (e.g., using reception component 802 and/or communication manager 806, depicted in FIG. 8) may receive, from the network node, an activation indication for the multi-PUSCH CG, the activation indication indicating one or more per-PUSCH uplink transmission parameters for multiple PUSCH communications associated with the multi-PUSCH CG, as described above.

As further shown in FIG. 6, in some aspects, process 600 may include transmitting, to the network node, the multiple PUSCH communications associated with the multi-PUSCH CG in accordance with the one or more per-PUSCH uplink transmission parameters (block 630). For example, the UE (e.g., using transmission component 804 and/or communication manager 806, depicted in FIG. 8) may transmit, to the network node, the multiple PUSCH communications associated with the multi-PUSCH CG in accordance with the one or more per-PUSCH uplink transmission parameters, as described above.

Process 600 may include additional aspects, such as any single aspect or any combination of aspects described below and/or in connection with one or more other processes described elsewhere herein.

In a first aspect, the one or more per-PUSCH uplink transmission parameters include at least one of per-PUSCH TDRAs, per-PUSCH FDRAs, or per-PUSCH MCSs for the multiple PUSCH communications associated with the multi-PUSCH CG.

In a second aspect, alone or in combination with the first aspect, the activation indication is included in DCI.

In a third aspect, alone or in combination with one or more of the first and second aspects, the multiple PUSCH communications associated with the multi-PUSCH CG are scheduled in respective slots, the configuration information indicates a TDRA table, and the activation indication includes, in a TDRA field, an indication of a row index associated with a row, of the TDRA table, that indicates a SLIV and a PUSCH mapping type that apply to the multiple PUSCH communications.

In a fourth aspect, alone or in combination with one or more of the first through third aspects, the multiple PUSCH communications are scheduled in respective consecutive slots, starting with a first slot associated with a first PUSCH communication of the multiple PUSCH communications, and the row further indicates a slot offset for the first slot associated with the first PUSCH communication.

In a fifth aspect, alone or in combination with one or more of the first through fourth aspects, the row further indicates a respective slot offset for each PUSCH communication of the multiple PUSCH communications.

In a sixth aspect, alone or in combination with one or more of the first through fifth aspects, the row further indicates a slot offset for a first PUSCH communication of the multiple PUSCH communications and a respective relative slot offset for each remaining PUSCH communication, other than the first PUSCH communication, of the multiple PUSCH communications.

In a seventh aspect, alone or in combination with one or more of the first through sixth aspects, the row further indicates a slot offset for a first PUSCH communication of the multiple PUSCH communications, and the activation indication further includes an indication of respective slot offsets or relative slot offsets for each remaining PUSCH communication, other than the first PUSCH communication, of the multiple PUSCH communications.

In an eighth aspect, alone or in combination with one or more of the first through seventh aspects, the activation indication further includes an indication of a bitmap including a plurality of bits, and each bit of the plurality of bits indicates whether a respective slot, of a plurality of slots, is scheduled with a PUSCH communication of the multiple PUSCH communications.

In a ninth aspect, alone or in combination with one or more of the first through eighth aspects, the configuration information indicates a quantity of the multiple PUSCH communications associated with the multi-PUSCH CG.

In a tenth aspect, alone or in combination with one or more of the first through ninth aspects, the configuration information includes an indication, in the configuration for the multi-PUSCH CG, of the quantity of the multiple PUSCH communications.

In an eleventh aspect, alone or in combination with one or more of the first through tenth aspects, the configuration information includes an indication of the quantity of the multiple PUSCH communications that applies to a plurality of configured grant configurations including the configuration for the multi-PUSCH CG.

In a twelfth aspect, alone or in combination with one or more of the first through eleventh aspects, the activation indication indicates a quantity of the multiple PUSCH communications associated with the multi-PUSCH CG.

In a thirteenth aspect, alone or in combination with one or more of the first through twelfth aspects, the quantity of the multiple PUSCH communications associated with the multi-PUSCH CG corresponds to a quantity of PUSCH communications configured for the row associated with the row index indicated in the TDRA field of the activation indication.

In a fourteenth aspect, alone or in combination with one or more of the first through thirteenth aspects, the multiple PUSCH communications associated with the multi-PUSCH CG include a number of consecutive PUSCH communications scheduled in each of one or more slots, the configuration information indicates a TDRA table, the activation indication includes, in a TDRA field, an indication of a row index associated with a row, of the TDRA table, that indicates a SLIV that applies to a first PUSCH communication of the number of consecutive PUSCH communications scheduled in each of the one or more slots, and the number of consecutive PUSCH communications scheduled in each of the one or more slots is indicated by the activation indication or the configuration information.

In a fifteenth aspect, alone or in combination with one or more of the first through fourteenth aspects, the multiple PUSCH communications associated with the multi-PUSCH CG are scheduled in respective nominal PUSCH occasions, the configuration information indicates a TDRA table, the activation indication includes, in a TDRA field, an indication of a row index associated with a row, of the TDRA table, that indicates a slot offset for a first slot associated with a first nominal PUSCH occasion of the respective nominal PUSCH occasions, a start symbol and allocation length that apply to the multiple PUSCH communications, and a PUSCH mapping type that applies to the multiple PUSCH communications, and, for each PUSCH communication of the multiple PUSCH communications, a starting slot, a starting symbol, an ending slot, and an ending symbol of the respective nominal PUSCH occasion are based at least in part on the first slot associated with the first nominal PUSCH occasion, the start symbol, the allocation length, and a number of symbols per slot.

In a sixteenth aspect, alone or in combination with one or more of the first through fifteenth aspects, the configuration information indicates a quantity of the multiple PUSCH communications associated with the multi-PUSCH CG.

In a seventeenth aspect, alone or in combination with one or more of the first through sixteenth aspects, the activation indication indicates a quantity of the multiple PUSCH communications associated with the multi-PUSCH CG.

In an eighteenth aspect, alone or in combination with one or more of the first through seventeenth aspects, the multiple PUSCH communications associated with the multi-PUSCH CG are scheduled in respective slots, the configuration information indicates a TDRA table, and the activation indication includes, in a TDRA field, an indication of a row index associated with a row, of the TDRA table, that indicates a respective SLIV and a respective PUSCH mapping type for each PUSCH communication of the multiple PUSCH communications.

In a nineteenth aspect, alone or in combination with one or more of the first through eighteenth aspects, the multiple PUSCH communications are scheduled in respective consecutive slots, starting with a first slot associated with a first PUSCH communication of the multiple PUSCH communications, and the row further indicates a slot offset for the first slot associated with the first PUSCH communication.

In a twentieth aspect, alone or in combination with one or more of the first through nineteenth aspects, the row further indicates a respective slot offset for each PUSCH communication of the multiple PUSCH communications.

In a twenty-first aspect, alone or in combination with one or more of the first through twentieth aspects, the row further indicates a slot offset for a first PUSCH communication of the multiple PUSCH communications and a respective relative slot offset for each remaining PUSCH communication, other than the first PUSCH communication, of the multiple PUSCH communications.

In a twenty-second aspect, alone or in combination with one or more of the first through twenty-first aspects, a quantity of the multiple PUSCH communications associated with the multi-PUSCH CG is indicated by a number of valid SLIVs indicated in the row.

In a twenty-third aspect, alone or in combination with one or more of the first through twenty-second aspects, the configuration information indicates a quantity of the multiple PUSCH communications associated with the multi-PUSCH CG.

In a twenty-fourth aspect, alone or in combination with one or more of the first through twenty-third aspects, the activation indication indicates, in an FDRA field, an FDRA that applies to the multiple PUSCH communications.

In a twenty-fifth aspect, alone or in combination with one or more of the first through twenty-fourth aspects, the activation indication includes multiple FDRA fields, each indicating an FDRA for a respective PUSCH communication of the multiple PUSCH communications.

In a twenty-sixth aspect, alone or in combination with one or more of the first through twenty-fifth aspects, the multiple FDRA fields are of equal length, and each FDRA field includes a respective FDRA type indication.

In a twenty-seventh aspect, alone or in combination with one or more of the first through twenty-sixth aspects, a first FDRA field, of the multiple FDRA fields, has a first length and includes an FDRA type indication that applies to the multiple FDRA fields, and each remaining FDRA field, other than the first FDRA field, of the multiple FDRA fields has a second length that is smaller than the first length.

In a twenty-eighth aspect, alone or in combination with one or more of the first through twenty-seventh aspects, the activation indication includes am FDRA field indicating an FDRA for a first PUSCH communication of the multiple PUSCH communications, and a respective FDRA adjustment field indicating a respective FDRA adjustment for each remaining PUSCH communication, other than the first PUSCH communication, of the multiple PUSCH communications.

In a twenty-ninth aspect, alone or in combination with one or more of the first through twenty-eighth aspects, the activation indication includes an FDRA field indicating an FDRA for a first PUSCH communication of the multiple PUSCH communications, and an FDRA adjustment field indicating a row index associated with a row, of a configured FDRA adjustment table, that indicates a respective FDRA adjustment for each remaining PUSCH communication, other than the first PUSCH communication, of the multiple PUSCH communications.

In a thirtieth aspect, alone or in combination with one or more of the first through twenty-ninth aspects, the activation indication indicates, in an MCS field, an MCS that applies to the multiple PUSCH communications.

In a thirty-first aspect, alone or in combination with one or more of the first through thirtieth aspects, the activation indication includes multiple MCS fields, each indicating an MCS for a respective PUSCH communication of the multiple PUSCH communications.

In a thirty-second aspect, alone or in combination with one or more of the first through thirty-first aspects, the activation indication includes an MCS field indicating an MCS for a first PUSCH communication of the multiple PUSCH communications, and a respective delta MCS field indicating a respective delta MCS for each remaining PUSCH communication, other than the first PUSCH communication, of the multiple PUSCH communications.

In a thirty-third aspect, alone or in combination with one or more of the first through thirty-second aspects, the activation indication includes an MCS field indicating an MCS for a first PUSCH communication of the multiple PUSCH communications, and a delta MCS field indicating a row index associated with a row, of a configured delta MCS table, that indicates a respective delta MCS for each remaining PUSCH communication, other than the first PUSCH communication, of the multiple PUSCH communications.

In a thirty-fourth aspect, alone or in combination with one or more of the first through thirty-third aspects, the activation indication includes, in an MCS field, an indication of a row index associated with a row, of a configured MCS table, that indicates a respective MCS for PUSCH communication of the multiple PUSCH communications.

In a thirty-fifth aspect, alone or in combination with one or more of the first through thirty-fourth aspects, the activation indication includes, in an MCS field, an indication of a row index associated with a row, of a configured MCS table, that indicates an MCS for a first PUSCH communication of the multiple PUSCH communications and a respective delta MCS for each remaining PUSCH communication, other than the first PUSCH communication, of the multiple PUSCH communications.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with activation indication for multi-PUSCH CG.

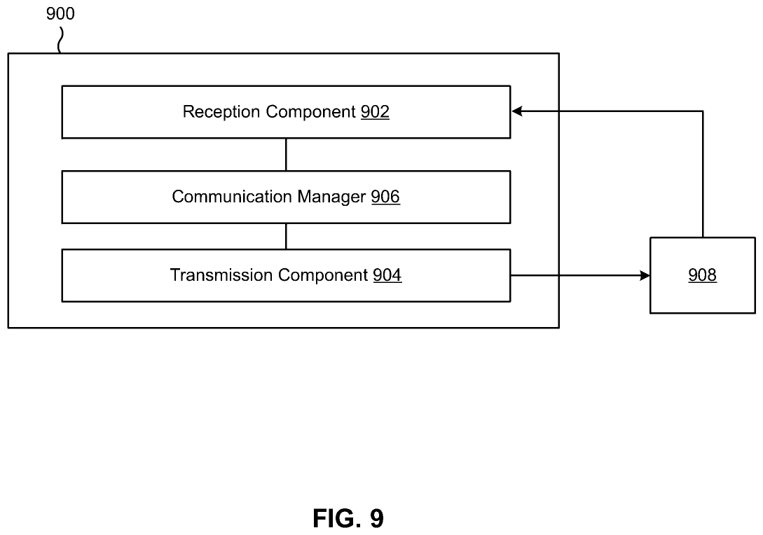

As shown in FIG. 7, in some aspects, process 700 may include transmitting, to a UE configuration information indicating a configuration for a multi-PUSH CG (block 710). For example, the network node (e.g., using transmission component 904 and/or communication manager 906, depicted in FIG. 9) may transmit, to a UE configuration information indicating a configuration for a multi-PUSH CG, as described above.

As further shown in FIG. 7, in some aspects, process 700 may include transmitting, to the UE, an activation indication for the multi-PUSCH CG, the activation indication indicating one or more per-PUSCH uplink transmission parameters for multiple PUSCH communications associated with the multi-PUSCH CG (block 720). For example, the network node (e.g., using transmission component 904 and/or communication manager 906, depicted in FIG. 9) may transmit, to the UE, an activation indication for the multi-PUSCH CG, the activation indication indicating one or more per-PUSCH uplink transmission parameters for multiple PUSCH communications associated with the multi-PUSCH CG, as described above.

As further shown in FIG. 7, in some aspects, process 700 may include receiving, from the UE, the multiple PUSCH communications associated with the multi-PUSCH CG in accordance with the one or more per-PUSCH uplink transmission parameters (block 730). For example, the network node (e.g., using reception component 902 and/or communication manager 906, depicted in FIG. 9) may receive, from the UE, the multiple PUSCH communications associated with the multi-PUSCH CG in accordance with the one or more per-PUSCH uplink transmission parameters, as described above.

Process 700 may include additional aspects, such as any single aspect or any combination of aspects described below and/or in connection with one or more other processes described elsewhere herein.

In a first aspect, the one or more per-PUSCH uplink transmission parameters include at least one of per-PUSCH TDRAs, per-PUSCH FDRAs, or per-PUSCH MCSs for the multiple PUSCH communications associated with the multi-PUSCH CG.

In a second aspect, alone or in combination with the first aspect, the activation indication is included in DCI.

In a third aspect, alone or in combination with one or more of the first and second aspects, the multiple PUSCH communications associated with the multi-PUSCH CG are scheduled in respective slots, the configuration information indicates a TDRA table, and the activation indication includes, in a TDRA field, an indication of a row index associated with a row, of the TDRA table, that indicates a SLIV and a PUSCH mapping type that apply to the multiple PUSCH communications.

In a fourth aspect, alone or in combination with one or more of the first through third aspects, the multiple PUSCH communications are scheduled in respective consecutive slots, starting with a first slot associated with a first PUSCH communication of the multiple PUSCH communications, and the row further indicates a slot offset for the first slot associated with the first PUSCH communication.

In a fifth aspect, alone or in combination with one or more of the first through fourth aspects, the row further indicates a respective slot offset for each PUSCH communication of the multiple PUSCH communications.

In a sixth aspect, alone or in combination with one or more of the first through fifth aspects, the row further indicates a slot offset for a first PUSCH communication of the multiple PUSCH communications and a respective relative slot offset for each remaining PUSCH communication, other than the first PUSCH communication, of the multiple PUSCH communications.

In a seventh aspect, alone or in combination with one or more of the first through sixth aspects, the row further indicates a slot offset for a first PUSCH communication of the multiple PUSCH communications, and the activation indication further includes an indication of respective slot offsets or relative slot offsets for each remaining PUSCH communication, other than the first PUSCH communication, of the multiple PUSCH communications.

In an eighth aspect, alone or in combination with one or more of the first through seventh aspects, the activation indication further includes an indication of a bitmap including a plurality of bits, and each bit of the plurality of bits indicates whether a respective slot, of a plurality of slots, is scheduled with a PUSCH communication of the multiple PUSCH communications.

In a ninth aspect, alone or in combination with one or more of the first through eighth aspects, the configuration information indicates a quantity of the multiple PUSCH communications associated with the multi-PUSCH CG.

In a tenth aspect, alone or in combination with one or more of the first through ninth aspects, the configuration information includes an indication, in the configuration for the multi-PUSCH CG, of the quantity of the multiple PUSCH communications.

In an eleventh aspect, alone or in combination with one or more of the first through tenth aspects, the configuration information includes an indication of the quantity of the multiple PUSCH communications that applies to a plurality of configured grant configurations including the configuration for the multi-PUSCH CG.

In a twelfth aspect, alone or in combination with one or more of the first through eleventh aspects, the activation indication indicates a quantity of the multiple PUSCH communications associated with the multi-PUSCH CG.

In a thirteenth aspect, alone or in combination with one or more of the first through twelfth aspects, the quantity of the multiple PUSCH communications associated with the multi-PUSCH CG corresponds to a quantity of PUSCH communications configured for the row associated with the row index indicated in the TDRA field of the activation indication.

In a fourteenth aspect, alone or in combination with one or more of the first through thirteenth aspects, the multiple PUSCH communications associated with the multi-PUSCH CG include a number of consecutive PUSCH communications scheduled in each of one or more slots, the configuration information indicates a TDRA table, the activation indication includes, in a TDRA field, an indication of a row index associated with a row, of the TDRA table, that indicates a SLIV that applies to a first PUSCH communication of the number of consecutive PUSCH communications scheduled in each of the one or more slots, and the number of consecutive PUSCH communications scheduled in each of the one or more slots is indicated by the activation indication or the configuration information.

In a fifteenth aspect, alone or in combination with one or more of the first through fourteenth aspects, the multiple PUSCH communications associated with the multi-PUSCH CG are scheduled in respective nominal PUSCH occasions, the configuration information indicates a TDRA table, the activation indication includes, in a TDRA field, an indication of a row index associated with a row, of the TDRA table, that indicates a slot offset for a first slot associated with a first nominal PUSCH occasion of the respective nominal PUSCH occasions, a start symbol and allocation length that apply to the multiple PUSCH communications, and a PUSCH mapping type that applies to the multiple PUSCH communications, and, for each PUSCH communication of the multiple PUSCH communications, a starting slot, a starting symbol, an ending slot, and an ending symbol of the respective nominal PUSCH occasion are based at least in part on the first slot associated with the first nominal PUSCH occasion, the start symbol, the allocation length, and a number of symbols per slot.

In a sixteenth aspect, alone or in combination with one or more of the first through fifteenth aspects, the configuration information indicates a quantity of the multiple PUSCH communications associated with the multi-PUSCH CG.

In a seventeenth aspect, alone or in combination with one or more of the first through sixteenth aspects, the activation indication indicates a quantity of the multiple PUSCH communications associated with the multi-PUSCH CG.

In an eighteenth aspect, alone or in combination with one or more of the first through seventeenth aspects, the multiple PUSCH communications associated with the multi-PUSCH CG are scheduled in respective slots, the configuration information indicates a TDRA table, and the activation indication includes, in a TDRA field, an indication of a row index associated with a row, of the TDRA table, that indicates a respective SLIV and a respective PUSCH mapping type for each PUSCH communication of the multiple PUSCH communications.

In a nineteenth aspect, alone or in combination with one or more of the first through eighteenth aspects, the multiple PUSCH communications are scheduled in respective consecutive slots, starting with a first slot associated with a first PUSCH communication of the multiple PUSCH communications, and the row further indicates a slot offset for the first slot associated with the first PUSCH communication.

In a twentieth aspect, alone or in combination with one or more of the first through nineteenth aspects, the row further indicates a respective slot offset for each PUSCH communication of the multiple PUSCH communications.

In a twenty-first aspect, alone or in combination with one or more of the first through twentieth aspects, the row further indicates a slot offset for a first PUSCH communication of the multiple PUSCH communications and a respective relative slot offset for each remaining PUSCH communication, other than the first PUSCH communication, of the multiple PUSCH communications.

In a twenty-second aspect, alone or in combination with one or more of the first through twenty-first aspects, a quantity of the multiple PUSCH communications associated with the multi-PUSCH CG is indicated by a number of valid SLIVs indicated in the row.

In a twenty-third aspect, alone or in combination with one or more of the first through twenty-second aspects, the configuration information indicates a quantity of the multiple PUSCH communications associated with the multi-PUSCH CG.

In a twenty-fourth aspect, alone or in combination with one or more of the first through twenty-third aspects, the activation indication indicates, in an FDRA field, an FDRA that applies to the multiple PUSCH communications.

In a twenty-fifth aspect, alone or in combination with one or more of the first through twenty-fourth aspects, the activation indication includes multiple FDRA fields, each indicating an FDRA for a respective PUSCH communication of the multiple PUSCH communications.

In a twenty-sixth aspect, alone or in combination with one or more of the first through twenty-fifth aspects, the multiple FDRA fields are of equal length, and each FDRA field includes a respective FDRA type indication.

In a twenty-seventh aspect, alone or in combination with one or more of the first through twenty-sixth aspects, a first FDRA field, of the multiple FDRA fields, has a first length and includes an FDRA type indication that applies to the multiple FDRA fields, and each remaining FDRA field, other than the first FDRA field, of the multiple FDRA fields has a second length that is smaller than the first length.

In a twenty-eighth aspect, alone or in combination with one or more of the first through twenty-seventh aspects, the activation indication includes an FDRA field indicating an FDRA for a first PUSCH communication of the multiple PUSCH communications, and a respective FDRA adjustment field indicating a respective FDRA adjustment for each remaining PUSCH communication, other than the first PUSCH communication, of the multiple PUSCH communications.

In a twenty-ninth aspect, alone or in combination with one or more of the first through twenty-eighth aspects, the activation indication includes an FDRA field indicating an FDRA for a first PUSCH communication of the multiple PUSCH communications, and an FDRA adjustment field indicating a row index associated with a row, of a configured FDRA adjustment table, that indicates a respective FDRA adjustment for each remaining PUSCH communication, other than the first PUSCH communication, of the multiple PUSCH communications.

In a thirtieth aspect, alone or in combination with one or more of the first through twenty-ninth aspects, the activation indication indicates, in an MCS field, an MCS that applies to the multiple PUSCH communications.

In a thirty-first aspect, alone or in combination with one or more of the first through thirtieth aspects, the activation indication includes multiple MCS fields, each indicating an MCS for a respective PUSCH communication of the multiple PUSCH communications.

In a thirty-second aspect, alone or in combination with one or more of the first through thirty-first aspects, the activation indication includes an MCS field indicating an MCS for a first PUSCH communication of the multiple PUSCH communications, and a respective delta MCS field indicating a respective delta MCS for each remaining PUSCH communication, other than the first PUSCH communication, of the multiple PUSCH communications.

In a thirty-third aspect, alone or in combination with one or more of the first through thirty-second aspects, the activation indication includes an MCS field indicating an MCS for a first PUSCH communication of the multiple PUSCH communications, and a delta MCS field indicating a row index associated with a row, of a configured delta MCS table, that indicates a respective delta MCS for each remaining PUSCH communication, other than the first PUSCH communication, of the multiple PUSCH communications.

In a thirty-fourth aspect, alone or in combination with one or more of the first through thirty-third aspects, the activation indication includes, in an MCS field, an indication of a row index associated with a row, of a configured MCS table, that indicates a respective MCS for PUSCH communication of the multiple PUSCH communications.

In a thirty-fifth aspect, alone or in combination with one or more of the first through thirty-fourth aspects, the activation indication includes, in an MCS field, an indication of a row index associated with a row, of a configured MCS table, that indicates an MCS for a first PUSCH communication of the multiple PUSCH communications and a respective delta MCS for each remaining PUSCH communication, other than the first PUSCH communication, of the multiple PUSCH communications.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5A-5B. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, from a network node, configuration information indicating a configuration for a multi-PUSH CG. The reception component 802 may receive, from the network node, an activation indication for the multi-PUSCH CG, the activation indication indicating one or more per-PUSCH uplink transmission parameters for multiple PUSCH communications associated with the multi-PUSCH CG. The transmission component 804 may transmit, to the network node, the multiple PUSCH communications associated with the multi-PUSCH CG in accordance with the one or more per-PUSCH uplink transmission parameters.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5A-5B. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to a UE configuration information indicating a configuration for a multi-PUSH CG. The transmission component 904 may transmit, to the UE, an activation indication for the multi-PUSCH CG, the activation indication indicating one or more per-PUSCH uplink transmission parameters for multiple PUSCH communications associated with the multi-PUSCH CG. The reception component 902 may receive, from the UE, the multiple PUSCH communications associated with the multi-PUSCH CG in accordance with the one or more per-PUSCH uplink transmission parameters.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving, from a network node, configuration information indicating a configuration for a multiple physical uplink shared channel (PUSCH) configured grant (multi-PUSH CG); receiving, from the network node, an activation indication for the multi-PUSCH CG, the activation indication indicating one or more per-PUSCH uplink transmission parameters for multiple PUSCH communications associated with the multi-PUSCH CG; and transmitting, to the network node, the multiple PUSCH communications associated with the multi-PUSCH CG in accordance with the one or more per-PUSCH uplink transmission parameters.

Aspect 2: The method of Aspect 1, wherein the one or more per-PUSCH uplink transmission parameters include at least one of per-PUSCH time domain resource allocations (TDRAs), per-PUSCH frequency domain resource allocations (FDRAs), or per-PUSCH modulation and coding schemes (MCSs) for the multiple PUSCH communications associated with the multi-PUSCH CG.

Aspect 3: The method of any of Aspects 1-2, wherein the activation indication is included in downlink control information (DCI).

Aspect 4: The method of any of Aspects 1-3, wherein the multiple PUSCH communications associated with the multi-PUSCH CG are scheduled in respective slots, wherein the configuration information indicates a time domain resource allocation (TDRA) table, and wherein the activation indication includes, in a TDRA field, an indication of a row index associated with a row, of the TDRA table, that indicates a start and length indicator value (SLIV) and a PUSCH mapping type that apply to the multiple PUSCH communications.

Aspect 5: The method of Aspect 4, wherein the multiple PUSCH communications are scheduled in respective consecutive slots, starting with a first slot associated with a first PUSCH communication of the multiple PUSCH communications, and wherein the row further indicates a slot offset for the first slot associated with the first PUSCH communication.

Aspect 6: The method of Aspect 4, wherein the row further indicates a respective slot offset for each PUSCH communication of the multiple PUSCH communications.

Aspect 7: The method of Aspect 4, wherein the row further indicates a slot offset for a first PUSCH communication of the multiple PUSCH communications and a respective relative slot offset for each remaining PUSCH communication, other than the first PUSCH communication, of the multiple PUSCH communications.

Aspect 8: The method of Aspect 4, wherein the row further indicates a slot offset for a first PUSCH communication of the multiple PUSCH communications, and wherein the activation indication further includes an indication of respective slot offsets or relative slot offsets for each remaining PUSCH communication, other than the first PUSCH communication, of the multiple PUSCH communications.

Aspect 9: The method of Aspect 4, wherein the activation indication further includes an indication of a bitmap including a plurality of bits, and wherein each bit of the plurality of bits indicates whether a respective slot, of a plurality of slots, is scheduled with a PUSCH communication of the multiple PUSCH communications.

Aspect 10: The method of any of Aspects 4-9, wherein the configuration information indicates a quantity of the multiple PUSCH communications associated with the multi-PUSCH CG.

Aspect 11: The method of Aspect 10, wherein the configuration information includes an indication, in the configuration for the multi-PUSCH CG, of the quantity of the multiple PUSCH communications.

Aspect 12: The method of Aspect 10, wherein the configuration information includes an indication of the quantity of the multiple PUSCH communications that applies to a plurality of configured grant configurations including the configuration for the multi-PUSCH CG.

Aspect 13: The method of any of Aspects 4-9, wherein the activation indication indicates a quantity of the multiple PUSCH communications associated with the multi-PUSCH CG.

Aspect 14: The method of Aspect 13, wherein the quantity of the multiple PUSCH communications associated with the multi-PUSCH CG corresponds to a quantity of PUSCH communications configured for the row associated with the row index indicated in the TDRA field of the activation indication.

Aspect 15: The method of any of Aspects 1-14, wherein the multiple PUSCH communications associated with the multi-PUSCH CG include a number of consecutive PUSCH communications scheduled in each of one or more slots, wherein the configuration information indicates a time domain resource allocation (TDRA) table, wherein the activation indication includes, in a TDRA field, an indication of a row index associated with a row, of the TDRA table, that indicates a start and length indicator value (SLIV) that applies to a first PUSCH communication of the number of consecutive PUSCH communications scheduled in each of the one or more slots, and wherein the number of consecutive PUSCH communications scheduled in each of the one or more slots is indicated by the activation indication or the configuration information.

Aspect 16: The method of any of Aspects 1-3, wherein the multiple PUSCH communications associated with the multi-PUSCH CG are scheduled in respective nominal PUSCH occasions, wherein the configuration information indicates a time domain resource allocation (TDRA) table, wherein the activation indication includes, in a TDRA field, an indication of a row index associated with a row, of the TDRA table, that indicates a slot offset for a first slot associated with a first nominal PUSCH occasion of the respective nominal PUSCH occasions, a start symbol and allocation length that apply to the multiple PUSCH communications, and a PUSCH mapping type that applies to the multiple PUSCH communications, and wherein, for each PUSCH communication of the multiple PUSCH communications, a starting slot, a starting symbol, an ending slot, and an ending symbol of the respective nominal PUSCH occasion are based at least in part on the first slot associated with the first nominal PUSCH occasion, the start symbol, the allocation length, and a number of symbols per slot.

Aspect 17: The method of Aspect 16, wherein the configuration information indicates a quantity of the multiple PUSCH communications associated with the multi-PUSCH CG.

Aspect 18: The method of Aspect 16, wherein the activation indication indicates a quantity of the multiple PUSCH communications associated with the multi-PUSCH CG.

Aspect 19: The method of any of Aspects 1-3, wherein the multiple PUSCH communications associated with the multi-PUSCH CG are scheduled in respective slots, wherein the configuration information indicates a time domain resource allocation (TDRA) table, and wherein the activation indication includes, in a TDRA field, an indication of a row index associated with a row, of the TDRA table, that indicates a respective start and length indicator value (SLIV) and a respective PUSCH mapping type for each PUSCH communication of the multiple PUSCH communications.

Aspect 20: The method of Aspect 19, wherein the multiple PUSCH communications are scheduled in respective consecutive slots, starting with a first slot associated with a first PUSCH communication of the multiple PUSCH communications, and wherein the row further indicates a slot offset for the first slot associated with the first PUSCH communication.

Aspect 21: The method of Aspect 19, wherein the row further indicates a respective slot offset for each PUSCH communication of the multiple PUSCH communications.

Aspect 22: The method of Aspect 19, wherein the row further indicates a slot offset for a first PUSCH communication of the multiple PUSCH communications and a respective relative slot offset for each remaining PUSCH communication, other than the first PUSCH communication, of the multiple PUSCH communications.

Aspect 23: The method of any of Aspects 19-22, wherein a quantity of the multiple PUSCH communications associated with the multi-PUSCH CG is indicated by a number of valid SLIVs indicated in the row.

Aspect 24: The method of any of Aspects 19-22, wherein the configuration information indicates a quantity of the multiple PUSCH communications associated with the multi-PUSCH CG.

Aspect 25: The method of any of Aspects 1-24, wherein the activation indication indicates, in a frequency domain resource allocation (FDRA) field, an FDRA that applies to the multiple PUSCH communications.

Aspect 26: The method of any of Aspects 1-24, wherein the activation indication includes multiple frequency domain resource allocation (FDRA) fields, each indicating an FDRA for a respective PUSCH communication of the multiple PUSCH communications.

Aspect 27: The method of Aspect 26, wherein the multiple FDRA fields are of equal length, and wherein each FDRA field includes a respective FDRA type indication.

Aspect 28: The method of Aspect 26, wherein a first FDRA field, of the multiple FDRA fields, has a first length and includes an FDRA type indication that applies to the multiple FDRA fields, and wherein each remaining FDRA field, other than the first FDRA field, of the multiple FDRA fields has a second length that is smaller than the first length.

Aspect 29: The method of any of Aspects 1-24, wherein the activation indication includes a frequency domain resource allocation (FDRA) field indicating an FDRA for a first PUSCH communication of the multiple PUSCH communications, and a respective FDRA adjustment field indicating a respective FDRA adjustment for each remaining PUSCH communication, other than the first PUSCH communication, of the multiple PUSCH communications.

Aspect 30: The method of any of Aspects 1-24, wherein the activation indication includes a frequency domain resource allocation (FDRA) field indicating an FDRA for a first PUSCH communication of the multiple PUSCH communications, and an FDRA adjustment field indicating a row index associated with a row, of a configured FDRA adjustment table, that indicates a respective FDRA adjustment for each remaining PUSCH communication, other than the first PUSCH communication, of the multiple PUSCH communications.

Aspect 31: The method of any of Aspects 1-30, wherein the activation indication indicates, in a modulation and coding scheme (MCS) field, an MCS that applies to the multiple PUSCH communications.

Aspect 32: The method of any of Aspects 1-30, wherein the activation indication includes multiple modulation and coding scheme (MCS) fields, each indicating an MCS for a respective PUSCH communication of the multiple PUSCH communications.

Aspect 33: The method of any of Aspects 1-30, wherein the activation indication includes a modulation and coding scheme (MCS) field indicating an MCS for a first PUSCH communication of the multiple PUSCH communications, and a respective delta MCS field indicating a respective delta MCS for each remaining PUSCH communication, other than the first PUSCH communication, of the multiple PUSCH communications.

Aspect 34: The method of any of Aspects 1-30, wherein the activation indication includes a modulation and coding scheme (MCS) field indicating an MCS for a first PUSCH communication of the multiple PUSCH communications, and a delta MCS field indicating a row index associated with a row, of a configured delta MCS table, that indicates a respective delta MCS for each remaining PUSCH communication, other than the first PUSCH communication, of the multiple PUSCH communications.

Aspect 35: The method of any of Aspects 1-30, wherein the activation indication includes, in a modulation and coding scheme (MCS) field, an indication of a row index associated with a row, of a configured MCS table, that indicates a respective MCS for PUSCH communication of the multiple PUSCH communications.

Aspect 36: The method of any of Aspects 1-30, wherein the activation indication includes, in a modulation and coding scheme (MCS) field, an indication of a row index associated with a row, of a configured MCS table, that indicates an MCS for a first PUSCH communication of the multiple PUSCH communications and a respective delta MCS for each remaining PUSCH communication, other than the first PUSCH communication, of the multiple PUSCH communications.

Aspect 37: A method of wireless communication performed by a network node, comprising: transmitting, to a user equipment (UE) configuration information indicating a configuration for a multiple physical uplink shared channel (PUSCH) configured grant (multi-PUSH CG); transmitting, to the UE, an activation indication for the multi-PUSCH CG, the activation indication indicating one or more per-PUSCH uplink transmission parameters for multiple PUSCH communications associated with the multi-PUSCH CG; and receiving, from the UE, the multiple PUSCH communications associated with the multi-PUSCH CG in accordance with the one or more per-PUSCH uplink transmission parameters.

Aspect 38: The method of Aspect 37, wherein the one or more per-PUSCH uplink transmission parameters include at least one of per-PUSCH time domain resource allocations (TDRAs), per-PUSCH frequency domain resource allocations (FDRAs), or per-PUSCH modulation and coding schemes (MCSs) for the multiple PUSCH communications associated with the multi-PUSCH CG.

Aspect 39: The method of any of Aspects 37-38, wherein the activation indication is included in downlink control information (DCI).

Aspect 40: The method of any of Aspects 37-39, wherein the multiple PUSCH communications associated with the multi-PUSCH CG are scheduled in respective slots, wherein the configuration information indicates a time domain resource allocation (TDRA) table, and wherein the activation indication includes, in a TDRA field, an indication of a row index associated with a row, of the TDRA table, that indicates a start and length indicator value (SLIV) and a PUSCH mapping type that apply to the multiple PUSCH communications.

Aspect 41: The method of Aspect 40, wherein the multiple PUSCH communications are scheduled in respective consecutive slots, starting with a first slot associated with a first PUSCH communication of the multiple PUSCH communications, and wherein the row further indicates a slot offset for the first slot associated with the first PUSCH communication.

Aspect 42: The method of Aspect 40, wherein the row further indicates a respective slot offset for each PUSCH communication of the multiple PUSCH communications.

Aspect 43: The method of Aspect 40, wherein the row further indicates a slot offset for a first PUSCH communication of the multiple PUSCH communications and a respective relative slot offset for each remaining PUSCH communication, other than the first PUSCH communication, of the multiple PUSCH communications.

Aspect 44: The method of Aspect 40, wherein the row further indicates a slot offset for a first PUSCH communication of the multiple PUSCH communications, and wherein the activation indication further includes an indication of respective slot offsets or relative slot offsets for each remaining PUSCH communication, other than the first PUSCH communication, of the multiple PUSCH communications.

Aspect 45: The method of Aspect 40, wherein the activation indication further includes an indication of a bitmap including a plurality of bits, and wherein each bit of the plurality of bits indicates whether a respective slot, of a plurality of slots, is scheduled with a PUSCH communication of the multiple PUSCH communications.

Aspect 46: The method of any of Aspects 40-45, wherein the configuration information indicates a quantity of the multiple PUSCH communications associated with the multi-PUSCH CG.

Aspect 47: The method of Aspect 46, wherein the configuration information includes an indication, in the configuration for the multi-PUSCH CG, of the quantity of the multiple PUSCH communications.

Aspect 48: The method of Aspect 46, wherein the configuration information includes an indication of the quantity of the multiple PUSCH communications that applies to a plurality of configured grant configurations including the configuration for the multi-PUSCH CG.

Aspect 49: The method of any of Aspects 40-45, wherein the activation indication indicates a quantity of the multiple PUSCH communications associated with the multi-PUSCH CG.

Aspect 50: The method of Aspect 49, wherein the quantity of the multiple PUSCH communications associated with the multi-PUSCH CG corresponds to a quantity of PUSCH communications configured for the row associated with the row index indicated in the TDRA field of the activation indication.

Aspect 51: The method of any of Aspects 37-50, wherein the multiple PUSCH communications associated with the multi-PUSCH CG include a number of consecutive PUSCH communications scheduled in each of one or more slots, wherein the configuration information indicates a time domain resource allocation (TDRA) table, wherein the activation indication includes, in a TDRA field, an indication of a row index associated with a row, of the TDRA table, that indicates a start and length indicator value (SLIV) that applies to a first PUSCH communication of the number of consecutive PUSCH communications scheduled in each of the one or more slots, and wherein the number of consecutive PUSCH communications scheduled in each of the one or more slots is indicated by the activation indication or the configuration information.

Aspect 52: The method of any of Aspects 37-39, wherein the multiple PUSCH communications associated with the multi-PUSCH CG are scheduled in respective nominal PUSCH occasions, wherein the configuration information indicates a time domain resource allocation (TDRA) table, wherein the activation indication includes, in a TDRA field, an indication of a row index associated with a row, of the TDRA table, that indicates a slot offset for a first slot associated with a first nominal PUSCH occasion of the respective nominal PUSCH occasions, a start symbol and allocation length that apply to the multiple PUSCH communications, and a PUSCH mapping type that applies to the multiple PUSCH communications, and wherein, for each PUSCH communication of the multiple PUSCH communications, a starting slot, a starting symbol, an ending slot, and an ending symbol of the respective nominal PUSCH occasion are based at least in part on the first slot associated with the first nominal PUSCH occasion, the start symbol, the allocation length, and a number of symbols per slot.

Aspect 53: The method of Aspect 52, wherein the configuration information indicates a quantity of the multiple PUSCH communications associated with the multi-PUSCH CG.

Aspect 54: The method of Aspect 52, wherein the activation indication indicates a quantity of the multiple PUSCH communications associated with the multi-PUSCH CG.

Aspect 55: The method of any of Aspects 37-39, wherein the multiple PUSCH communications associated with the multi-PUSCH CG are scheduled in respective slots, wherein the configuration information indicates a time domain resource allocation (TDRA) table, and wherein the activation indication includes, in a TDRA field, an indication of a row index associated with a row, of the TDRA table, that indicates a respective start and length indicator value (SLIV) and a respective PUSCH mapping type for each PUSCH communication of the multiple PUSCH communications.

Aspect 56: The method of Aspect 55, wherein the multiple PUSCH communications are scheduled in respective consecutive slots, starting with a first slot associated with a first PUSCH communication of the multiple PUSCH communications, and wherein the row further indicates a slot offset for the first slot associated with the first PUSCH communication.

Aspect 57: The method of Aspect 55, wherein the row further indicates a respective slot offset for each PUSCH communication of the multiple PUSCH communications.

Aspect 58: The method of Aspect 55, wherein the row further indicates a slot offset for a first PUSCH communication of the multiple PUSCH communications and a respective relative slot offset for each remaining PUSCH communication, other than the first PUSCH communication, of the multiple PUSCH communications.

Aspect 59: The method of any of Aspects 55-58, wherein a quantity of the multiple PUSCH communications associated with the multi-PUSCH CG is indicated by a number of valid SLIVs indicated in the row.

Aspect 60: The method of any of Aspects 55-58, wherein the configuration information indicates a quantity of the multiple PUSCH communications associated with the multi-PUSCH CG.

Aspect 61: The method of any of Aspects 37-60, wherein the activation indication indicates, in a frequency domain resource allocation (FDRA) field, an FDRA that applies to the multiple PUSCH communications.

Aspect 62: The method of any of Aspects 37-60, wherein the activation indication includes multiple frequency domain resource allocation (FDRA) fields, each indicating an FDRA for a respective PUSCH communication of the multiple PUSCH communications.

Aspect 63: The method of Aspect 62, wherein the multiple FDRA fields are of equal length, and wherein each FDRA field includes a respective FDRA type indication.

Aspect 64: The method of Aspect 62, wherein a first FDRA field, of the multiple FDRA fields, has a first length and includes an FDRA type indication that applies to the multiple FDRA fields, and wherein each remaining FDRA field, other than the first FDRA field, of the multiple FDRA fields has a second length that is smaller than the first length.

Aspect 65: The method of any of Aspects 37-60, wherein the activation indication includes a frequency domain resource allocation (FDRA) field indicating an FDRA for a first PUSCH communication of the multiple PUSCH communications, and a respective FDRA adjustment field indicating a respective FDRA adjustment for each remaining PUSCH communication, other than the first PUSCH communication, of the multiple PUSCH communications.

Aspect 66: The method of any of Aspects 37-60, wherein the activation indication includes a frequency domain resource allocation (FDRA) field indicating an FDRA for a first PUSCH communication of the multiple PUSCH communications, and an FDRA adjustment field indicating a row index associated with a row, of a configured FDRA adjustment table, that indicates a respective FDRA adjustment for each remaining PUSCH communication, other than the first PUSCH communication, of the multiple PUSCH communications.

Aspect 67: The method of any of Aspects 37-66, wherein the activation indication indicates, in a modulation and coding scheme (MCS) field, an MCS that applies to the multiple PUSCH communications.

Aspect 68: The method of any of Aspects 37-66, wherein the activation indication includes multiple modulation and coding scheme (MCS) fields, each indicating an MCS for a respective PUSCH communication of the multiple PUSCH communications.

Aspect 69: The method of any of Aspects 37-66, wherein the activation indication includes a modulation and coding scheme (MCS) field indicating an MCS for a first PUSCH communication of the multiple PUSCH communications, and a respective delta MCS field indicating a respective delta MCS for each remaining PUSCH communication, other than the first PUSCH communication, of the multiple PUSCH communications.

Aspect 70: The method of any of Aspects 37-66, wherein the activation indication includes a modulation and coding scheme (MCS) field indicating an MCS for a first PUSCH communication of the multiple PUSCH communications, and a delta MCS field indicating a row index associated with a row, of a configured delta MCS table, that indicates a respective delta MCS for each remaining PUSCH communication, other than the first PUSCH communication, of the multiple PUSCH communications.

Aspect 71: The method of any of Aspects 37-66, wherein the activation indication includes, in a modulation and coding scheme (MCS) field, an indication of a row index associated with a row, of a configured MCS table, that indicates a respective MCS for PUSCH communication of the multiple PUSCH communications.

Aspect 72: The method of any of Aspects 37-66, wherein the activation indication includes, in a modulation and coding scheme (MCS) field, an indication of a row index associated with a row, of a configured MCS table, that indicates an MCS for a first PUSCH communication of the multiple PUSCH communications and a respective delta MCS for each remaining PUSCH communication, other than the first PUSCH communication, of the multiple PUSCH communications.

Aspect 73: An apparatus for wireless communication at a device, comprising a processor; memory coupled with the processor; and instructions stored in the memory and executable by the processor to cause the apparatus to perform the method of one or more of Aspects 1-72.

Aspect 74: A device for wireless communication, comprising a memory and one or more processors coupled to the memory, the one or more processors configured to perform the method of one or more of Aspects 1-72.

Aspect 75: An apparatus for wireless communication, comprising at least one means for performing the method of one or more of Aspects 1-72.

Aspect 76: A non-transitory computer-readable medium storing code for wireless communication, the code comprising instructions executable by a processor to perform the method of one or more of Aspects 1-72.

Aspect 77: A non-transitory computer-readable medium storing a set of instructions for wireless communication, the set of instructions comprising one or more instructions that, when executed by one or more processors of a device, cause the device to perform the method of one or more of Aspects 1-72.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive, from a network node, configuration information indicating a configuration for a multiple physical uplink shared channel (PUSCH) configured grant (multi-PUSH CG);
receive, from the network node, an activation indication for the multi-PUSCH CG, the activation indication indicating one or more per-PUSCH uplink transmission parameters for multiple PUSCH communications associated with the multi-PUSCH CG; and
transmit, to the network node, the multiple PUSCH communications associated with the multi-PUSCH CG in accordance with the one or more per-PUSCH uplink transmission parameters.

2. The UE of claim 1, wherein the multiple PUSCH communications associated with the multi-PUSCH CG are scheduled in respective slots, wherein the configuration information indicates a time domain resource allocation (TDRA) table, and wherein the activation indication includes, in a TDRA field, an indication of a row index associated with a row, of the TDRA table, that indicates a start and length indicator value (SLIV) and a PUSCH mapping type that apply to the multiple PUSCH communications.

3. The UE of claim 2, wherein the multiple PUSCH communications are scheduled in respective consecutive slots, starting with a first slot associated with a first PUSCH communication of the multiple PUSCH communications, and wherein the row further indicates a slot offset for the first slot associated with the first PUSCH communication.

4. The UE of claim 2, wherein the row further indicates a respective slot offset for each PUSCH communication of the multiple PUSCH communications.

5. The UE of claim 2, wherein the row further indicates a slot offset for a first PUSCH communication of the multiple PUSCH communications and a respective relative slot offset for each remaining PUSCH communication, other than the first PUSCH communication, of the multiple PUSCH communications.

6. The UE of claim 2, wherein the row further indicates a slot offset for a first PUSCH communication of the multiple PUSCH communications, and wherein the activation indication further includes an indication of respective slot offsets or relative slot offsets for each remaining PUSCH communication, other than the first PUSCH communication, of the multiple PUSCH communications.

7. The UE of claim 2, wherein the activation indication further includes an indication of a bitmap including a plurality of bits, and wherein each bit of the plurality of bits indicates whether a respective slot, of a plurality of slots, is scheduled with a PUSCH communication of the multiple PUSCH communications.

8. The UE of claim 2, wherein the configuration information indicates a quantity of the multiple PUSCH communications associated with the multi-PUSCH CG.

9. The UE of claim 2, wherein the activation indication indicates a quantity of the multiple PUSCH communications associated with the multi-PUSCH CG.

10. The UE of claim 9, wherein the quantity of the multiple PUSCH communications associated with the multi-PUSCH CG corresponds to a quantity of PUSCH communications configured for the row associated with the row index indicated in the TDRA field of the activation indication.

11. The UE of claim 1, wherein the multiple PUSCH communications associated with the multi-PUSCH CG include a number of consecutive PUSCH communications scheduled in each of one or more slots, wherein the configuration information indicates a time domain resource allocation (TDRA) table, wherein the activation indication includes, in a TDRA field, an indication of a row index associated with a row, of the TDRA table, that indicates a start and length indicator value (SLIV) that applies to a first PUSCH communication of the number of consecutive PUSCH communications scheduled in each of the one or more slots, and wherein the number of consecutive PUSCH communications scheduled in each of the one or more slots is indicated by the activation indication or the configuration information.

12. The UE of claim 1, wherein the multiple PUSCH communications associated with the multi-PUSCH CG are scheduled in respective nominal PUSCH occasions,
wherein the configuration information indicates a time domain resource allocation (TDRA) table,
wherein the activation indication includes, in a TDRA field, an indication of a row index associated with a row, of the TDRA table, that indicates a slot offset for a first slot associated with a first nominal PUSCH occasion of the respective nominal PUSCH occasions, a start symbol and allocation length that apply to the multiple PUSCH communications, and a PUSCH mapping type that applies to the multiple PUSCH communications, and
wherein, for each PUSCH communication of the multiple PUSCH communications, a starting slot, a starting symbol, an ending slot, and an ending symbol of the respective nominal PUSCH occasion are based at least in part on the first slot associated with the first nominal PUSCH occasion, the start symbol, the allocation length, and a number of symbols per slot.

13. The UE of claim 1, wherein the multiple PUSCH communications associated with the multi-PUSCH CG are scheduled in respective slots, wherein the configuration information indicates a time domain resource allocation (TDRA) table, and wherein the activation indication includes, in a TDRA field, an indication of a row index associated with a row, of the TDRA table, that indicates a respective start and length indicator value (SLIV) and a respective PUSCH mapping type for each PUSCH communication of the multiple PUSCH communications.

14. The UE of claim 13, wherein the multiple PUSCH communications are scheduled in respective consecutive slots, starting with a first slot associated with a first PUSCH communication of the multiple PUSCH communications, and wherein the row further indicates a slot offset for the first slot associated with the first PUSCH communication.

15. The UE of claim 13, wherein the row further indicates a respective slot offset for each PUSCH communication of the multiple PUSCH communications.

16. The UE of claim 13, wherein the row further indicates a slot offset for a first PUSCH communication of the multiple PUSCH communications and a respective relative slot offset for each remaining PUSCH communication, other than the first PUSCH communication, of the multiple PUSCH communications.

17. The UE of claim 13, wherein a quantity of the multiple PUSCH communications associated with the multi-PUSCH CG is indicated by a number of valid SLIVs indicated in the row.

18. The UE of claim 1, wherein the activation indication indicates, in a frequency domain resource allocation (FDRA) field, an FDRA that applies to the multiple PUSCH communications.

19. The UE of claim 1, wherein the activation indication includes multiple frequency domain resource allocation (FDRA) fields, each indicating an FDRA for a respective PUSCH communication of the multiple PUSCH communications.

20-28. (canceled)

29. A method of wireless communication performed by a user equipment (UE), comprising:
receiving, from a network node, configuration information indicating a configuration for a multiple physical uplink shared channel (PUSCH) configured grant (multi-PUSH CG);
receiving, from the network node, an activation indication for the multi-PUSCH CG, the activation indication indicating one or more per-PUSCH uplink transmission parameters for multiple PUSCH communications associated with the multi-PUSCH CG; and
transmitting, to the network node, the multiple PUSCH communications associated with the multi-PUSCH CG in accordance with the one or more per-PUSCH uplink transmission parameters.

30. (canceled)
